(19) United States
(12) Patent Application Publication
(10) Pub. No.: US 2026/0206672 A1
(43) Pub. Date: Jul. 23, 2026

(54) SYSTEMS AND METHODS FOR RAPID SEED PRE-SCREENING

(71) Applicant: SYNGENTA CROP PROTECTION AG, Basel (CH)

(72) Inventors: Mark McClure, Slater, IA (US); Ulrich Stephan Hannappel, Slater, IA (US); Suparna Kanjilal, Durham, NC (US)

(73) Assignee: SYNGENTA CROP PROTECTION AG, Basel (CH)

(21) Appl. No.: 19/140,918

(22) PCT Filed: Dec. 20, 2023
(86) PCT No.: PCT/US23/85005

§ 371 Date: Jun. 18, 2025

Related U.S. Application Data
(60) Provisional application No. 63/476,456, filed on Dec. 21, 2022.

(51) Int. Cl. A01C 1/00

(52) U.S. Cl. CPC A01C 1/00

(57) ABSTRACT

A method for analyzing a population of seeds comprising creating an orifice in each seed of the population of seeds, thereby exposing a portion of a cotyledon or endosperm of the seed; removing debris from the orifice; applying a first solution into contact with the orifice and onto the exposed portion of the cotyledon or endosperm, thereby forming a seed soak solution from the seed; and removing the seed soak solution while preserving germination viability of the seed. Applying a solution into the exposed orifice of the seed creates a seed soak solution in situ from which a biological molecule representative of an attribute of the individual seed, such as DNA indicative of a trait, can be isolated and analyzed.

### CROSS-REFERENCE TO RELATED APPLICATIONS

This application claims priority to, and the benefit of, U.S. Provisional Patent Application No. 63/476,456 , titled Methods and Systems for Automated Seed Sampling, filed on Dec. 21, 2022, which is incorporated herein in its entirety by reference.

### TECHNICAL FIELD

Various embodiments of the present disclosure pertain generally to systems and methods for screening plant materials for certain attributes. More specifically, particular embodiments of the present disclosure relate to more rapid and efficient systems and methods for screening plant seeds, such as in breeding programs, by isolating DNA from the seeds while retaining seed viability. This method is useful for various plant seeds, such as crop seeds, grain seeds, vegetable seeds, and flower seeds.

### BACKGROUND

Plant research in the agriculture industry is performed to continuously provide genetic improvements in the germplasm, such as to introduce desired traits into plants (e.g., traits that enhance vigor, yield, disease resistance, drought resistance, herbicide tolerance, etc.). A number of different processes are used to introduce genetic improvements into plant germplasm, such as selective breeding, gene editing, genetic manipulations, targeted mutations, transformation, etc. Upon introduction of a desired genetic trait, plants are grown over multiple generations to ensure that the trait has become stably incorporated into the plant's genome. However, due to differences in recombination, not all seeds of a plant will include the desired trait. Therefore, to develop a stable line, all seeds harvested from a plant typically need to be germinated and grown. Plants with the desired trait are moved forward in a breeding program while plants lacking or not expressing adequate levels of the desired trait are culled. In recent years, seed sampling methods have been developed wherein trait analysis is performed at the seed level to eliminate the need for germinating the seeds and growing the resulting plants, thereby reducing the greenhouse or field space requirement. Seeds with the desired trait are moved forward in the breeding pipeline while seeds not expressing adequate levels of the desired trait are culled.

One example approach for seed sampling is shown by Deppermann et al. in WO2006026466A2. Therein, each seed is “chipped” to remove a portion (or “chip”) that is analyzed for the presence of a desired trait. The seed is chipped such that the remainder of the seed retains viability and can be propagated, as needed.

However, the inventors herein have identified various issues with such approaches. In particular, there may be issues with sample handling. As one example, each seed has to be chipped with precision to ensure that embryonic matter is not removed, which could affect seed viability. Errors in sample removal can occur due to natural variations in seed size and shape. To reduce errors, costly equipment may be required to visualize and orient the seed properly before it can be chipped. Also due to the precision with which only non-embryonic matter needs to be removed, the approach may be limited to certain types of seeds, such as those having a threshold size. For example, the approach may not be applicable to seeds that are too small to handle by the system (e.g., tomato seeds, lettuce seeds, flower seeds, cereal seeds, etc.). As another example, significant logistics are required to maintain the correct association of the seed chip (sample) with the corresponding chipped seed. In particular, since the sample is directed to a sample tray distinct from a seed tray where the chipped seed is directed, significant resources, such as laboratory information management systems/software (LIMS) are required to track the position of the sample in the sample tray and correlate it with the position of the seed in the seed tray, as well as correlate the sample analysis data (e.g., DNA sequence data) with the identity of both the seed and the chipped sample. Typically, such LIMS systems can be cost, energy and memory intensive. As still another example, due to the small size of the seed chip and its transportation along ducting via air pressure, there is a possibility of sample drift wherein the sample strays from the intended well of the sample tray to another well. This can corrupt sampling results, create an incorrect association between sample and seed, and cause other contamination issues. In other words, the approach requires precise seed holding, cutting, and manipulation of small seed chips and careful seed to chip identity tracking.

Another approach to seed sampling is disclosed by Hannappel et al. in U.S. Pat. No. 10,011,828B2 wherein a maize seed is fully submerged in a solution from which DNA can be extracted. The seed is subsequently dried and germinated. However, the inventors herein have identified issues with this approach. As one example, the method requires a number of labware consumables. As another example, the approach may be limited by seed type. For example, submerging a soybean seed in an alkali solution may cause the seed coat to fall off and viability of the soaked seed to be compromised. As still another example, the alkali solution that is optimized for DNA extraction may not be compatible with downstream processes such as PCR or sequencing methods.

Accordingly, there is a need in the art for improved methods and systems for seed sampling while retaining seed viability. The present disclosure addresses at least some of the above issues by providing a method and system for in-seed sampling which simplifies sample collection and tracking, is compatible with a variety of seed types and downstream sample processing steps, and maintains the viability of the sampled seed.

### SUMMARY

According to certain aspects of the present disclosure, systems and methods for in-seed sampling are disclosed. The method enables a biological material indicative of a plant trait, such as DNA, to be directly extracted from a seed after which the same seed can be germinated.

Embodiments of the invention include a method for analyzing a seed or a population of seeds, the method comprising: affixing a population of seeds into a receptacle; creating an orifice in at least one seed of the population of seeds, thereby exposing a portion of a cotyledon or endosperm of the at least one seed; removing seed debris from the orifice; applying a solution into the orifice and onto the exposed portion of the cotyledon or endosperm, thereby forming a seed soak solution from the seed; and removing the seed soak solution while preserving germination viability of the seed or population of seeds. In some embodiments, the method is performed for each seed of the population of seeds. Some embodiments of the method further comprise analyzing the seed soak solution to determine an attribute of the seed and selecting one or more seeds of the population of the seeds for germination based on the presence or absence of the attribute.

Some embodiments of the invention further include a system for analyzing a seed or a population of seeds, comprising: a receptacle configured for receiving a population of seeds, wherein the population of seeds have a defined relationship relative to each other in the receptacle; a cutting device configured for creating an orifice in at least one seed of the population of seeds to thereby expose a portion of a cotyledon or endosperm (or other portion) of the at least one seed; a cleaning tool configured for removing debris generated at the at least one seed by the cutting device and/or from the created orifice; a soak solution tool configured for (i) applying a solution into the orifice and onto the exposed portion of the cotyledon or endosperm to thereby form a seed soak solution in the seed; (ii) removing the seed soak solution from the seed; and (iii) dispensing the seed soak solution into a sample analysis container. In some embodiments, the orifice created by the cutting device is configured such that a sample collection “well” is created, in situ, in the endosperm or cotyledon portion of the seed. In particular embodiments, the seed soak solution is configured to enable, for example, DNA, RNA, protein or carbohydrate extraction directly from the exposed cotyledon or endosperm without affecting the ability of the seed to germinate.

It is to be understood that both the foregoing general description and the following detailed description are examples and explanatory only and are not restrictive of the disclosed embodiments, as claimed.

### BRIEF DESCRIPTION OF THE DRAWINGS

The accompanying drawings, which are incorporated in and constitute a part of this specification, illustrate various example embodiments and together with this description, serve to explain the principles of the disclosed embodiments.

FIG. 1 is a schematic depiction of an example embodiment of a method for in-seed sampling applicable to a population of seeds.

FIG. 2 is a high-level flowchart of an example embodiment of a method for in-seed sampling, such as the method of FIG. 1.

FIG. 3 is an example embodiment of a receptacle for receiving and affixing seeds for in-seed sampling.

FIG. 4A is another example embodiment of a receptacle for receiving and affixing seeds for in-seed sampling.

FIG. 4B is an example embodiment of an aligner plate in use with a receptacle for receiving and affixing seeds for in-seed sampling.

FIG. 5A is an example embodiment of an alignment tool used to align seeds in a receptacle to a common depth or plane.

FIG. 5B is another example embodiment of an aligner plate in use with a receptacle for receiving and affixing seeds for in-seed sampling.

FIG. 6 is an example embodiment of a drilling device that may be used to create an orifice for exposing a portion of a seed or population of seeds for analysis.

FIG. 7 is an example embodiment of a cleaning tool that may be used to remove debris from the orifice of a seed following, or concurrent to, the action of an associated drilling device.

FIG. 8 is an example embodiment of a receptacle for receiving and affixing seeds in a second orientation for in-seed sampling after they have been drilled and cleaned in a first orientation.

FIG. 9 is an example embodiment of a method for in-seed sampling wherein seeds are affixed, drilled and cleaned in a first orientation followed by being affixed in a second orientation for biological material extraction.

FIG. 10 is an amplification plot depicting relative DNA yield and quality from an in-seed sampling test in accordance with the disclosed invention.

FIGS. 11 and 12 are allelic PCR endpoint plots depicting allelic separation in DNA isolated using from an in-seed sampling test of corn seed in accordance with the disclosed invention.

FIG. 13 is an allelic PCR endpoint plot depicting allelic separation in DNA isolated using from an in-seed sampling test of soy seed in accordance with the disclosed invention.

FIG. 14 is a schematic depiction of an example embodiment of a receptacle for receiving and affixing seeds for in-seed sampling.

### DETAILED DESCRIPTION

Reference will now be made in detail to the example embodiments of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, system, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel. As used herein, the term “exemplary” is used in the sense of “example,” rather than “ideal.” Moreover, the terms “a” and “an” herein do not denote a limitation of quantity, but rather denote the presence of one or more of the referenced items.

The present disclosure provides a method for in-seed sampling comprising holding and fixturing a seed, removing a region of the seed to expose an area of endosperm or cotyledon (or other portion of the seed), disposing the removed region so that a “sampling region” is created in situ in the seed, pipetting a solution for analysis directly into contact with the exposed sampling region of the seed, and based on the analysis, determining whether to select the seed for progress into a breeding pipeline. In some embodiments, at least some of the steps of the method are automated and do not require user input, while other steps may require user input. In other embodiments, all the steps of the method are automated and do not require user input. The disclosure also includes apparatuses, individual components, and systems for performing the in-seed sampling methods of the invention. In certain embodiments, the apparatuses, individual components, and systems are semi-automated or fully automated. Further, the disclosure includes methods and systems, including automated systems and methods, for liquid DNA, protein, or RNA isolation, seed storage, as well as seed selection and retrieval. It should be noted that in some embodiments, a portion of the seed other than the cotyledon or endosperm may be exposed for subsequent seed analysis, such as, for example, the seed coat.

As elaborated herein, the methods and systems of in-seed sampling provide various advantages. First, by removing a portion of the seed to create an orifice or “well” in the seed and disposing of the removed seed debris, the seed effectively acts as both the seed and the sample. By eliminating the need for a sample that is distinct from the seed, a variety of sample handling issues such as sample drift and the need for complex sample tracking systems (e.g., expensive LIMS systems) is reduced. Second, the requirement for only a portion of the seed to be exposed for in-seed sampling allows for customization of a cutting device (e.g., a drill) and a cutting operation (e.g., drilling operation) based on seed type. For example, different cutting tools can be developed based on seed size and shape, seed coat thickness, seed oil content, and similarly cutting operations may extend the cutting device to different depths of the seed based on the relative position of the embryo in the seed relative to the endosperm/cotyledon. Further, although in some embodiments the dispensed solution may come in contact with at least a portion of the seed coat, in other embodiments, contact between the dispensed solution and the seed coat may be purposely minimized. For example, in some embodiments, a combination of the volume of the in-seed “well” created by the cutting device and the components of the solution dispensed into the seed for extracting a biological molecule therefrom (e.g., solutions for extracting DNA, RNA, protein, carbohydrate, etc.) may be optimized. As such, exposure of the seed contents to the solution may be limited, which may improve seed viability, and germination efficiency and reduce seed coat fall-off issues.

The present disclosure also allows for usage of fewer consumables, such as fewer seed trays and sample trays, labware, and reagents by virtue of making the seed itself a vessel for the liquid handling step. By eliminating the need for distinct sample trays and seeds trays, the need for complex tracking systems for correlating the trays is also reduced. In some embodiments, the receptacle into which seeds are affixed for performing the in-seed sampling may be reusable. Depending on the extraction protocol used for the biological molecule(s), this approach can also eliminate the need for lab materials related to shaking, grinding, centrifugation, and incubation. Overall, a rapid in-seed sampling method and system can be enabled with fewer steps and components.

Selective seed breeding has been made more systematic by procedures that allow the plant breeder to isolate DNA material. DNA analysis allows the breeder to identify seeds with preferred genetic characteristics, and to use only those seeds to propagate progeny plants from which additional seeds are selected to be harvested. Particular embodiments of the present disclosure enable in-seed DNA sampling by cutting into (e.g., drilling) and exposing a portion of the inner seed region following by direct application of a solution, configured for extracting DNA, to the exposed inner seed region. The methods result in an in-seed solution comprising seed DNA, and a viable seed. The in-seed sampling method can be similarly used to extract and analyze proteins, carbohydrates, RNA, and/or other biological molecules from a seed. By analyzing the biological molecule (e.g., DNA) from the in-seed solution, a breeder can quickly determine if the seed should be propagated or culled. By enabling earlier determination of seed characteristics, greenhouse and field resource usage can be minimized and seed selection decisions can be made earlier in the breeding pipeline, if desired. For example, seeds can be advanced into a Single Seed Descent (SSD) program in an earlier generation (than otherwise possible), if desired.

The disclosed methods, apparatuses, and systems are also compatible with existing and upcoming DNA sequencing-based technologies, such as Skim sequencing and Genotyping by Sequencing (GBS), including tunable Genotyping by Sequencing (tGBS), due to the need for small DNA liquid volumes (about 4-10 uL, depending on pre-QC steps, for multiple assays). The methods and apparatus and systems are also compatible with legacy genotyping assays like Taqman or KASP, where higher volumes of DNA and/or DNA concentration can be required. In systems that require larger volumes, including legacy genotyping chemistries, the in-seed extraction step can be repeated multiple times, or an additional cavity can be formed in the seed to hold a larger volume. Furthermore, the extraction solution can be configured to be compatible with the downstream PCR and sequencing approaches.

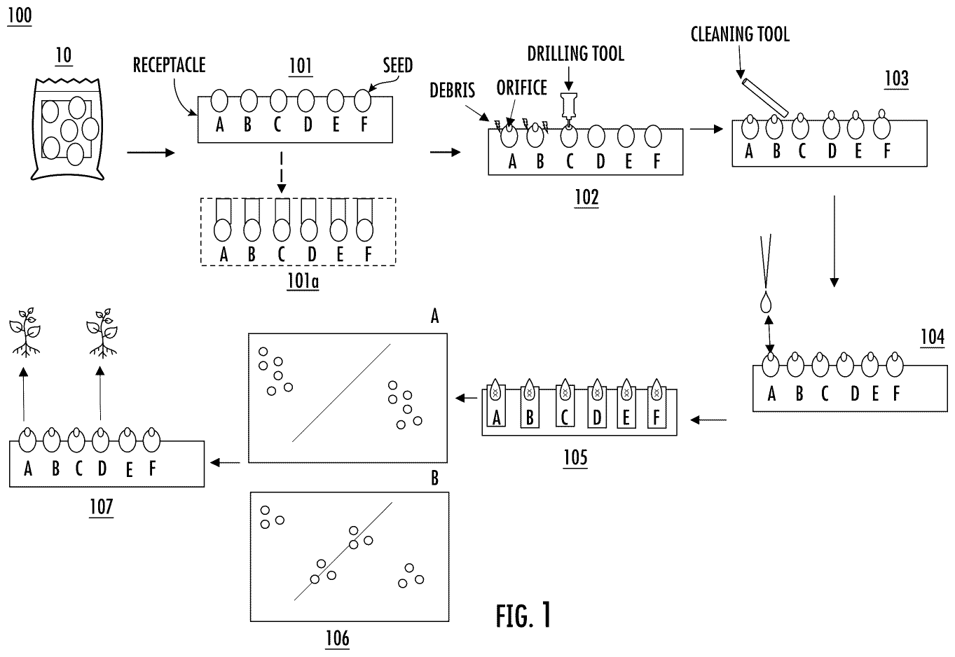

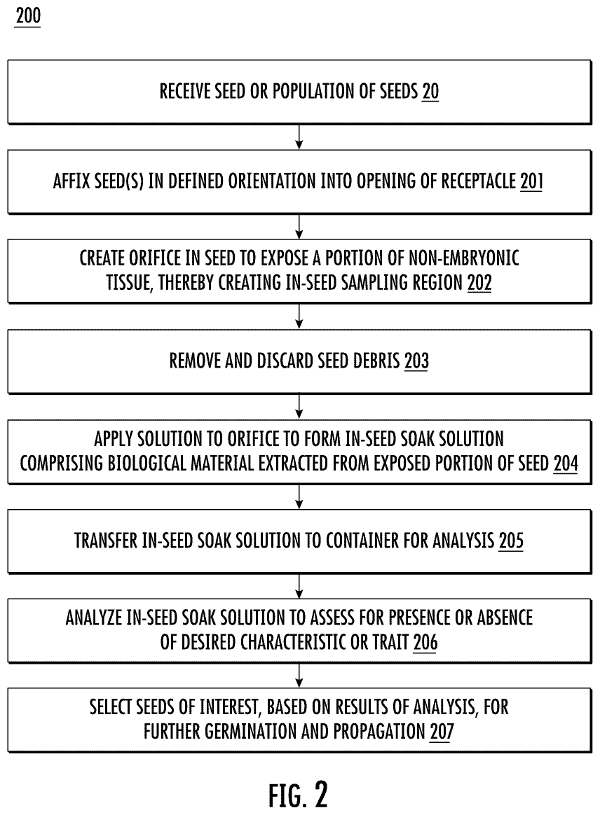

An example method for in-seed sampling is now discussed with reference to FIG. 1 (which shows a schematic representation of an example method 100) and FIG. 2 (which shows a high-level flowchart 200 of the example method). Some embodiments of the method of FIGS. 1-2 may be performed by an in-seed sampling device or system automatically and/or autonomously, without user input, such as by a robot optionally aided by machine vision. In other embodiments, the method may be performed semi-automatically wherein at least some of the steps are performed automatically, e.g., by a robot, while at least some other steps are performed manually by a user. One or more example embodiments of components, device, tools and/or apparatus that can be used to perform one or more steps of the disclosed method are introduced at FIGS. 1-2 and elaborated in further detail thereafter.

In-seed sampling method 100, 200 (FIGS. 1 and 2, respectively) starts with obtaining a seed, or a population of seeds (step 10, 20). For example, in some embodiments a population of seeds may comprise a collection of seeds, such as, for example, contained in a seed packet or seed bag, which may be obtained containing seeds for sampling. In some examples, an identifier on the bag (e.g., barcode or other “bag tag”) may be scanned and an identity of the seed packet or seed bag may be saved in a data management system associated with the in-seed sampling device. In some embodiments, the population of seeds is a bulked population or a single seed descent population. In other embodiments, the population of seeds includes hybrid seeds from a selected parent plant (e.g., all F2 or all F3 seeds from a plant, plant line, or plant crossing) or inbred or backcrossed seeds (e.g., BC1, BC2, etc.). The seed(s) may be sourced from any plant. As non-limiting examples, the seed(s) may be a crop seed (e.g., seeds from corn (dent/field corn or sweet corn), soy, sunflower, rapeseed, cotton, etc.), cereal seeds (e.g., seeds from corn, barley, wheat, rice, oat, etc.), vegetable seeds (e.g., seeds from bean, brassica, cucumber, lettuce, melon, okra, pepper, spinach, squash, tomato, etc.), fruit seeds (e.g. seeds from melons including watermelon, pear, apple etc.), flower seeds, as well as tree seeds. For purposes of the present disclosure, and the following descriptions, a population of seeds may comprise a single seed or multiple seeds (e.g., more than one seed such as a bulk population of seeds).

After obtaining a seed or population of seeds, the method includes affixing the seed or a population of seeds into a receptacle (step 101, 201). In some embodiments, affixing the seed includes orienting the seed in a predefined orientation (e.g., placing the seed in a pre-determined position). In other embodiments, such as where the seed is self-orienting, affixing the seed includes placing the seed in the opening without the need for active orientation adjustments. For example, seeds may be dispensed into the receptacle from a hopper while shaking the receptacle so that the seeds are oriented (e.g., self-oriented) upon entering the receptacle. Alternatively, the ducting via which the seeds are released from the hopper into the receptacle may be shaken.

In some embodiments, the common orientation in which the seeds are affixed in the receptacle may include each seed being coplanar or tangential with a surface of the receptacle, so that the exposed side or area of the seed or population of seeds is uniform. In one embodiment, a crown of each seed is used to position the population of seeds in the common orientation. The crown may be aligned such that the crown is coplanar with or tangential to the surface of the receptacle. In one example embodiment, individual openings of the receptacle may be sized and shaped to receive a corn seed/kernel in the predefined common orientation where the bottom of the corn kernel extends into the opening while the crown of the corn kernel extends out of the opening or is approximately coplanar with the top surface of the receptable. In other embodiments, the openings of the receptacle may be configured to receive the seed in any orientation and upon shaking the receptacle, the seeds may self-orient. This may be advantageous for self-orienting seeds such as soy seeds. In still further embodiments, the openings of the receptacle may be configured to receive the seeds in a flat orientation with the seed lying on a dorsal or ventral side. This may be advantageous for seeds that are less rounded, such as pumpkin seeds or sunflower seeds.

In one embodiment, the receptacle comprises a plurality of openings (or channels), arranged in an array, wherein each opening is sized and shaped to receive a seed of a population in a common, predefined orientation or configuration. The openings define channels into which individual seeds are received. In some embodiments, the number and position of openings in the receptacle is designed to be compatible with standard automated liquid handling platforms. For example, the size of the receptacle and position of openings therein may be configured to match 96-well, 384-well, or 3897-well plates that are routinely used by liquid handling platforms. In still other examples, the plates and openings may be sized and positioned in a manner that is customized to the specific seed type or sampling assay type.

The openings in the receptacle may follow a subset of the Society of Biomolecular Screening (SBS) microplate standards, for example, by providing 96 storage locations in an 8×12 well format with a 9 mm pitch on both columns and rows with outer footprint dimensions of approximately 127.76 mm×85.48 mm. By utilizing the SBS form factor, compatibility of the receptacle with a wide variety of off-the-shelf liquid handlers, plate storage robots, robotic plate stackers, plate moving robots, plate moving axis/axes, and analysis tools for laboratory automation, is increased. By leveraging the SBS plate format, it allows for cost-effective end-to-end automation for receptacle handling, labeling, seed loading, exposing endosperm, pipetting, and unloading for final seed selection. In some embodiments, the receptacle is made out of inexpensive plastic or foam so the process can be inexpensively scaled up to hundreds or thousands of receptacles, and furthermore, such receptacles can be reused. Other materials may include biodegradable material such as plant-based plastics (e.g., corn or soy or bamboo plastic), corrugated paper, cardboard, etc. For track and trace purposes, each receptacle has an attached human or computer readable identifier or label, barcode, RFID, NFC, Bluetooth, UWB, and/or pick-to-light tracker, or similar tracking technology.

In some embodiments, each receptacle is labeled with an identifier, such as with a barcode or other human-readable or machine-readable identifier, to allow for ease of tracking. As elaborated hereinbelow, after completion of the in-seed sample extraction, seeds may be stored in the corresponding receptacles until a selection of seeds is made for further processing and/or propagation.

In some embodiments, receptacles with different opening sizes may be provided based on the seed type being sampled and/or to account for different seed size ranges of a given seed type. For example, a different receptacle may be used when sampling corn seeds versus soy seeds or tomato seeds. Different opening diameters may be provided to accommodate different seed girths, or different seed size girths, and can range from 0.05 mm to 1 mm, or 1 mm to 6 mm, or greater. In one example embodiment, the openings are 4 mm in diameter. In some embodiments, the opening dimensions may be configured to provide a tight fit for the affixed seed. In particular, if the seed is not affixed tightly in the receptacle opening, it may spin during the subsequent cutting step.

In various embodiments a receptacle can be made of any material configured for retaining one or more seeds, including deformable or nondeformable materials. For example, in some embodiments, a receptacle may be made of a nondeformable material, such as, for example, a metal material, a rigid plastic material, or a natural material, such as, for example, a wood material. In other embodiments, a receptacle may be made of a deformable material, such as, for example, a foam material. Other deformable materials are also possible, including, for example, a cork material.

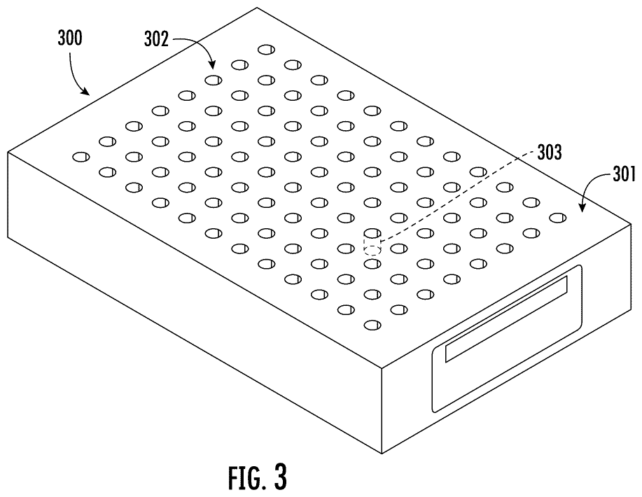

An example embodiment of a receptacle 300 that may be used for affixing the seeds for in-seed sampling is shown at FIG. 3. As shown therein, and detailed hereinbelow, the receptacle 300 of the depicted embodiment comprises a surface 301 having a number of openings 302 into which individual seeds may be affixed. Each opening 302 defines a channel or well 303 extending through the receptable and configured to hold an individual seed of the population of seeds, such that the population of seeds shares a substantially common orientation within the receptacle. For example, each seed may be affixed with a crown portion at the surface or extending beyond the surface, while a tail or bottom portion of the seed is positioned at the bottom of the channel or well. In other embodiments, the crown portion of the seed may extend below the surface.

Returning to FIGS. 1-2, in the depicted embodiment seeds may be affixed into the receptacle openings manually (e.g., by an operator), or through the use of automation (e.g., using a multi-axial robot arm). Manually affixing the seeds into the receptacle may include a user placing the seeds into designated receptacle openings in a desired orientation. In some embodiments, the desired orientation is one where a region of the endosperm or cotyledon is exposed for subsequent cutting (e.g., drilling) steps. As noted above, in some embodiments where the receptacle is made of a material that is deformable (e.g., phenolic or polyisocyanurate foam material), manually affixing the seeds may include the user pushing the seeds into the receptacle material to instantaneously form a cavity or well wherein the seed is embedded in the desired orientation. The material may be prescored and/or drilled (e.g., with dimples or other markings) to indicate desired sites of seed affixation so that an array of the affixed seeds can be easily formed in the receptacle. In one example, the receptacle is prescored so that seeds can be affixed in a 96, 384 or 3897 well configuration.

In some embodiments, the seeds may alternatively be placed in the receptacles through the use of automation, such as the use of a multi-axial industrial robot arm. In one example embodiment, an industrial 6-axis robot work cell is equipped with one or more of a shaker bowl, machine vision camera and light, and a custom end-effector with grips, suction cups, and/or a vacuum head to pick up individual seeds from a collection of seeds, and place individual seeds into the receptacle openings, or push individual seeds into the seed receptacle (e.g., at the prescored locations) to create the openings with the seed embedded therein. In some embodiments, the robot arm may include optical sensors and/or machine vision systems via which individual seeds are oriented, after being picked from the collection of seeds, and before being placed into the receptacle in the desired orientation. This may be advantageous, for example, in certain embodiments using corn seeds so that each seed (or kernel) is placed in the receptacle opening with the crown exposed and the bottom of the seed at the bottom of the receptable well.

In one example embodiment, a population of seeds is received in a bin, and a seed is singulated from the population of seeds by a lifting platform coupled to the bin, the seed raised away from the remainder of the seeds of the population by a suction cup at the terminal end of the lifting platform. The lifting platform is sized to hold only a single seed, and the singulated seed is rotated on the platform while an optical sensor (e.g., camera or fixed position distance sensor, etc.) captures an optical attribute of the seed such as to confirm the presence of a single seed on the lifting platform and/or an outside profile of the seed. Following analysis of the optical data received from the sensor, seed placement is carried out via a robotic arm, such as by the robotic arm picking up the seed from the lifting platform and placing it in a target opening of the receptacle.

In another example embodiment, a population of seeds may be spread out on a plate or other surface, wherein a seed is singulated from the population of seeds. In various embodiments, the seed may be singulated using a variety of different methods including a lifting platform as described above, and/or other methods, including, but not limited to, a rotating disc having one or more holes or indentations configured to hold a single seed. In still other examples, a seed may be manually singulated from the population of seeds.

In some embodiments, seeds are affixed in the receptacle in a manner such that all seeds are substantially at the same working height. That is, each seed is exposed from the receptacle opening by substantially the same amount. One advantage of aligning the seeds in a common plane and to a common working height facilitates use of automation equipment without the need for advanced camera vision systems or 3D profiling. In some examples, after loading seeds at varying heights, an aligner tool comprising pins or prongs of a predefined length may be used to push all seeds down to a defined working height or plane. This can be particularly advantageous in systems where the receptacle is made of a deformable material. Herein, after affixing the seeds to the receptacle openings or prescored markings, either manually or using automation, the aligner tool can be placed over receptacle such that pins align with the receptacle openings or markings. Pressure is then applied on the aligner tool causing the pins to push the seeds to a common depth or plane in the receptacle openings. In some embodiments, the seed may be pushed into the receptacle to a depth that results in a cavity being created above the crown of the seed (see e.g., 101a in FIG. 1). This may be advantageous in creating an ex-seed soaking region in the opening or channel of the receptacle that is communicatively coupled to the in-seed soaking region after an orifice is created in the seed. The ex-seed soaking region may facilitate seed preprocessing and/or handling of larger soak solution volumes. For example, after affixing the seeds, a preprocessing solution may be delivered to the ex-seed soaking region to pre-soften at least the crown of the seed thereby improving the efficiency of creating an orifice in the seed crown (e.g., by requiring less force) and/or improve yield of biological materials (e.g., DNA) from the seed during sampling.

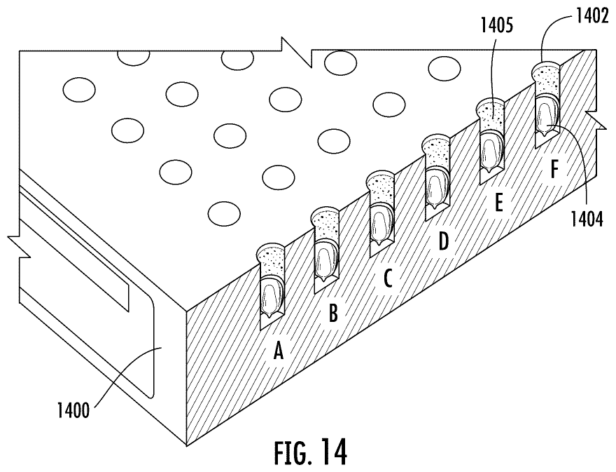

As noted above, in some example embodiments, each seed of a population of seeds may be pressed downward or otherwise located below the surface of the receptacle such that solution dispensed into the openings may be located above the top portion (such as, for example, the crown) of each seed. FIG. 14 illustrates an example of a receptacle 1400 that includes seeds 1404 located in openings 1402 below a top surface of the receptacle 1400. In such a manner, respective wells 1405 are formed above each seed 1404, which, as will be described in more detail below, may contain the solution for contact with an orifice formed in the seed 1404. In such embodiments, because the solution is located above the orifice formed in the seed and the remaining portions of the seed are surrounded by the receptacle, exposure of the seed coating (such as, for example, areas of the seed other than the orifice) to the solution may be minimized. It should be noted that although he seeds 1404 of FIG. 14 are illustrated as having the same working height, in other embodiments, each seed could be located at any working height below the surface of the receptacle. In such a manner, various seeds of a population of seeds may have different working heights. In various embodiments, the amount of solution above a seed may vary. Furthermore, in various embodiments the extent to which the seed coat is in contact with the solution may vary. For example, in various embodiments the top of the seed coat may be in contact with the solution. In certain embodiments less than 75% of the seed coat surface area is in contact with the solution, in another embodiment less than 50% of the seed coat surface area is in contact with the solution, in another embodiment less than 40%, in another embodiment less than 30%, in another embodiment less than 25%, in another embodiment less than 20%, in another embodiment less than 15%, in another embodiment less than 10%, in another embodiment less than 5%, and in another embodiment less than 1% of the seed coat surface area is in contact with the solution. Other embodiments include, but are not limited to, as a percentage of the overall seed coat surface area in contact with the solution, 1-5%, 5-10%, 10-15%, 15-20%, 20-25%, 25-30%, 30-40%, or more, and any value therebetween.

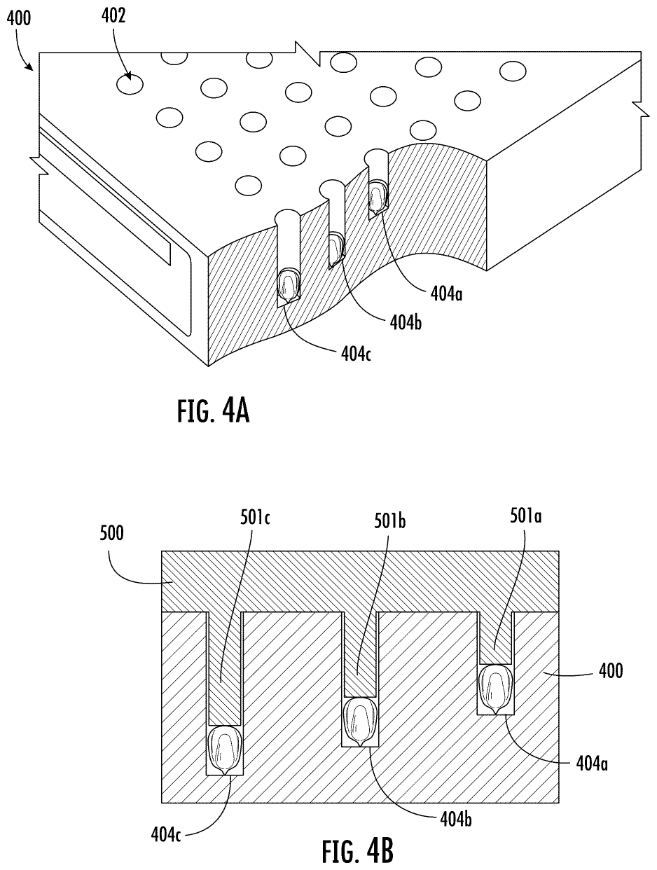

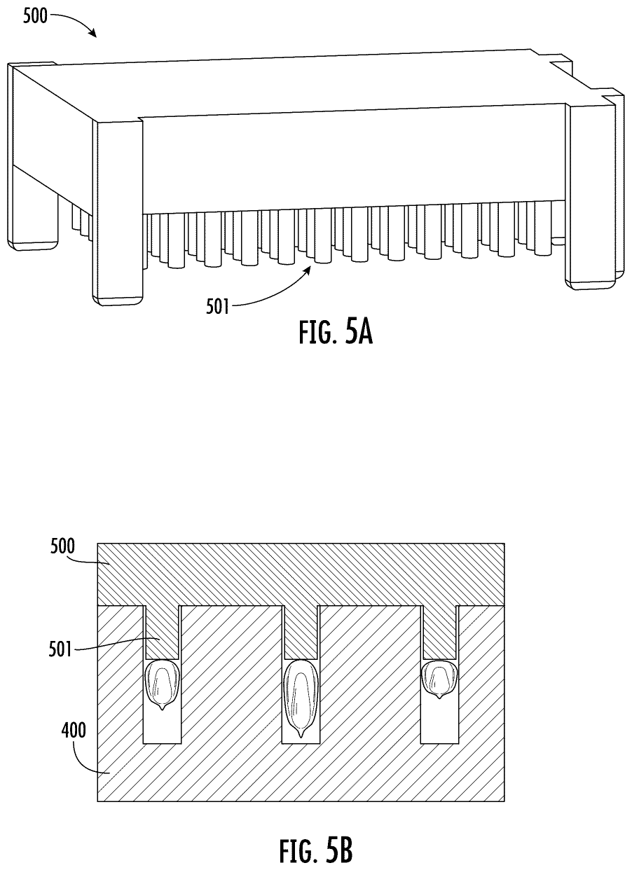

An example embodiment of affixing seeds 404 into a deformable receptacle 400 and pushing them to different depths 404a, 404b, 404c based on seed type to create an additional ex-seed soaking region is shown at FIG. 4A. An example embodiment of an aligner plate 500 that may be used to position seeds to a common depth or plane in the receptacle, such as the receptacle of FIG. 3 or 4A is shown at FIG. 5A, which in particular, depicts an aligner plate 500 comprising a number of prongs 501 (e.g., elongate pushers or extensions) that correspond to the positions of actual or desired openings in a receptacle for affixing seeds. Although in the embodiment depicted in FIG. 5A, the prongs 501 are substantially cylindrical and substantially the same length, in other embodiments the prongs may have different shapes and/or may have varying lengths so as to position seeds to varying depths. FIG. 4B illustrates a portion of an example aligner plate 500 such as may be used to affix the seeds of FIG. 4A at different depths. In particular, as shown in the figure, in some embodiments the prongs 501a, 501b, 501c of the aligner plate 500 may have different lengths so as to position respective seeds at different depths 404a, 404b, 404c.

Returning to FIG. 4A, the receptacle 400 of FIG. 4A has a number of openings 402 into which a seed 404 may be affixed. In some embodiments, each opening 402 is configured to hold an individual seed 404 of the population of seeds, where the population of seeds shares a substantially common orientation within the receptacle. In the depicted embodiment, openings 402 are used to increase the ease of manually affixing seeds with an XY pitch-spacing that correctly matches downstream computer numerical control (CNC) milling programs and liquid handler channel spacing. In some embodiments, the opening 404 may not form a cavity or channel for holding the seed but instead may be configured as a prescored or dimpled area indicative of where seeds may be placed. In some embodiments, for automated affixing, openings may not need to be pre-formed if the robotic system is able to place seeds on an accurate pitch without pitch placement indicators.

In some embodiments, the receptacle is made of a foam material, such as an open or closed cell foam material. A preferred embodiment of the receptacle 400 of FIG. 4A comprises a phenol foam or a microcellular foam block. When using the microcellular foam, openings may be required in order to affix the population of seeds. This may not be the case when using phenol foam, which can deform and hold the seeds without an opening. Low compression foam can also be used for the receptacle. An example of low compression set foam is PORON® 4701-40 Soft, which is an open cell foam made of microcellular polyurethane, and manufactured by Rogers Corporation. Although a variety of foam densities may be used, some example embodiments have foam densities ranging from about 0.75 lbs/ft³ to about 2.5 lbs/ft³. Foam densities above or below this range are also possible. Although a variety of compression force deflections may be used, some example embodiments have compression force deflection of about 2 psi to about 25 psi. Foam compression force deflections above or below this range are also possible. Any type of compliant material may work for fixturing the seeds, including but not limited to materials such as natural rubber, EDPM rubber, latex foam, polyurethane foam, EVA foam, polyethylene, gum foam, silicone foam, silicone, polyimide foam, phenol foam, Buna-n foam, nylon foam, Viton foam, Styrofoam, a gel, or the like. General categories of foam like open cell foam, closed cell foam, memory foam, spray foams, synthetic rubbers, impression foams, or 3D printed rubber-like substances, or the like may also work. The compliant material may be laser cut, die cut, plotter cut, or cut using any other manufacturing process known to the art.

In the depicted embodiment, each opening 402 defines a potential channel through which the seed can be pushed into the foam receptacle 400 providing enough displacement, compliance, grip, and compression support to reliably hold and affix the seed in place without dislodging or moving during subsequent process steps. The shape of the opening or prescored dimples in the foam receptacle are not limited to circles but could also include slots, ovals, rectangles, slits, 3-dimensional recesses, or any other combination of geometry. In some embodiments, when using an automated system to affix seeds, the openings may not be pre-formed in the receptacle. Rather, the automated system can be programmed to affix seeds at predetermined points in the foam receptacle, without requiring any placement indication on the surface. Alternatively, a series of dimples can be used in place of openings, where affixing the population of seeds into the receptacle comprises applying a force to drive the seeds into the receptacle so that the seeds are held in a common orientation within the dimple. Through holes in a cover over the receptacle surface can also be used with an automated system, as it may be easier to fabricate using a laser cutter in a polyurethane foam. A blind hole with a bottom is also contemplated. In other embodiments, the holes or dimples may be created in the foam prior to affixing the seeds.

By using a compliant material, in some example embodiments the seeds may be pushed into the holes, substantially allowing all seeds to be on the same working plane. When all seeds are in known coordinates and aligned along the same plane, machinery can operate on the seeds more easily without more advanced camera vision systems or 3D profiling. Optionally, after loading seeds at varying heights, an aligner plate (e.g., the aligner of FIG. 5A) may be used to push all seeds down to a known working height/plane in the receptacle.

In some embodiments, the opening in the receptacle may be configured such that the seed, upon affixing, is coincident to the surface of the receptacle, or offset from the surface. Furthermore, following affixation, the seed can be pushed deeper into the opening to allow for an orifice subsequently drilled into the seed to be exposed to an additional solution volume (FIG. 4A-B).

As noted, although in various embodiments other configurations are possible, the aligner plate 500 of FIG. 5A comprises a number of prongs 501 of similar dimension and length that correspond to the position of actual or desired openings in a receptacle for affixing seeds. By applying a uniform amount of force with a uniform prong array, a population of seeds in a receptacle can be affixed to a similar depth within a receptacle, regardless of seed shape. FIG. 5B illustrates a portion of an aligner plate 500 having prongs 501 of similar dimension and shape, which are configured to affix seeds of different sizes to similar depths within the receptacle 400. In some embodiments, the aligner plate 500 can be used when manually affixing seeds or configured for use by a robotic arm.

In addition to the disclosed embodiments, seed affixing can additionally or optionally be accomplished by one or more of the following options:
i. Using glue (such as cyanoacrylates, hot-melts, silicone, and the like).
ii. Using an injection molded or 3D printed receptacle made of a pliable material, such as rubber, wherein the receptacle comprises 3-dimensional geometry capable of fitting to a seed shape.
iii. Vacuum forming a piece of thin thermoplastic around the seeds in a manner similar to blister packaging, to hold the seed in place.
iv. Using a 2+ finger claw or grabber (e.g., similar to a screw grabber).
v. Using a clamp with jaws containing a negative cavity configured to hold the seed (e.g., in the shape complementary to the seed) being affixed to the receptacle.
vi. Using a clamp made of a compliant material.
vii. Using adhesive tapes.
viii. Using vacuum cups shaped to conform to the seed, with vacuum applied.
ix. Using a spring steel clip (e.g., a binder clip) or wire spring wire enclosing/wrapping the seed.
x. Using a full plastic deformation foam material such as phenolic foam.
xi. In some embodiments, instead of placing individual corn kernels in the receptacle, the corn seeds may be kept on the cob and the in-seed sampling system and method may be configured to be performed directly on the cob (e.g., while rotating the cob). In such a manner, the seeds may be considered affixed (via the cob) by a mechanism configured to hold and/or manipulate the cob.

Next, the method 100, 200 of the depicted embodiment includes, at step 102, 202, creating an orifice in the seed to expose a portion of non-embryonic tissue of the seed. Generally, the orifice is created by a cutting operation such as, for example, drilling, puncturing, perforating, or otherwise cutting into the seed, such as through the protective seed coating. In such a manner, in various embodiments, an orifice may be considered a puncture, cut, channel, well, well-like structure, etc. in the seed. As noted, such structures may be created in variety of ways, such as, for example, via puncturing, piercing, drilling, and/or any other suitable means. In such a manner, a solution can then be dispensed into the orifice.

As a result of creating the orifice, in some embodiments a portion of the endosperm or cotyledon is removed. As noted, while in the depicted embodiments a cutting operation comprising a drilling operation is depicted and described, it will be appreciated that other suitable manners of creating an orifice may be used, including but not limited to, piercing, boring, cutting, grinding, abrasing, or any other form of penetrating the seed coat to thereby expose the endosperm or cotyledon of the seed. In some embodiments, based on the configuration of the seed (e.g., for a corn seed) the orifice is created in the crown region of the seed to expose a portion of the underlying endosperm or cotyledon area. In some embodiments, the orifice is not created in, and/or does not extend into, the embryonic region of the seed. By limiting the orifice to the endosperm area, viability of the seed may be maintained, and the same seed can be used for germination and propagation into a plant after seed sampling.

The inventors herein have recognized that by creating an orifice in the seed (such as, for example, by drilling, puncturing, perforating, or otherwise cutting into the endosperm or cotyledon area to create an orifice in the seed), the seed itself can be used for obtaining a genetic sample. That is, a well can be created in situ in the seed into which a sampling solution can be delivered for seed analysis. In this way, the need for a seed sample distinct from the seed is obviated. By making the seed itself the sample on which analysis can be directly performed, various issues associated with seed chip/sample handling are overcome.

Optionally, the method may include removing a portion or all of the seed coat at the crown of each seed prior to creating the orifice. In various embodiments, removing the seed coat can be done manually or automatically.

Optionally, the seed may be partially or fully soaked in water or another solution that softens the seed coat, prior to creating the orifice. Presoaking the seed can reduce the amount of debris generated during the creation of the orifice. In some embodiments, the presoaking can also improve the yield of biological material (e.g., DNA, RNA, protein, and/or carbohydrate) from the seed. In some embodiments, only the top of the seed may be soaked to minimize seed coat exposure to the solution.

In still other embodiments, a seed-coat or pericarp removal step may be performed prior to placing the seed in the receptacle, or while the seed is in the receptacle.

One or more of a variety of cutting devices may be used to create the orifice. For example, a variety of different rotary cutting machines may be used, including, but not limited to, a drill, a Dremel® rotary tool or like device, a router, a milling machine, a cutting wheel, a coring device, etc. Such machines may employ one or more cutting tools such as, for example, drilling tools including a router bit, an endmill, or a drill bit. Other cutting tools may include a burr or the like. In certain embodiments, a cutting tool may be coupled to a CNC machine. In other embodiments, a liquid handling platform can be customized to incorporate a cutting tool. For example, a pipetting head of a liquid handling station may be replaced with a cutting tool. Still other methods may be used for creating the orifice and exposing the non-embryonic tissue including, but not limited to, laser-based cutting or ablation, use of a manual cutting device such as a blade or knife, a nichrome cutting wire, use of positive pressure from an air jet or water jet, and/or sandblasting a portion of the seed coating and non-embryonic tissue.

In some embodiments, based on seed type, such as seed size, seed shape, seed coat type, position of seed embryo relative to cotyledon(s), seed oil content, etc., an appropriate cutting tool may be selected for use in creating the orifice. Further still, the cutting tool may be selected based on the size and shape of orifice desired, which itself may be a function of sample volume desired or required for the assay of a given biological material (e.g., based on whether seed DNA or seed protein is to be assayed).

As one example, the cutting tool may comprise a downcutting router bit, such as a ½ inch, ¼-inch, ⅓ inch, ⅕ inch, ⅛ inch, or a 1/10 inch downcutting router bit may be used for crop seeds. As another example, an upcutting router bit, such as a ½ inch, ¼-inch, ⅓-inch, ⅕ inch, ⅛ inch, or a 1/10 inch upcutting router bit may be used for crop seeds. In one particular embodiment, a downcutting ⅛-inch router bit may be used for corn and soybean seeds. For example, a drill bit diameter of 0.5 mm, 1 mm, 2 mm, 3 mm, 4 mm, 5 mm, or larger may be drilled to a depth of 0.2 mm, 0.3 mm, 0.5 mm, 0.75 mm, 0.8 mm, 0.9 mm, 1 mm, 1.5 mm, 2 mm, 3 mm, 4 mm, 5 mm, or greater depth. As such, any diameter appropriately sized to the bounds of the seed may be used. Similarly, any drill depth may be used as long as sufficient clearance is made away from the embryo. For example, a drill bit may be used that generates a diameter that is 0.1%, 0.25%, 0.5%, 1%, 1.5%, 2%, 2.5%, 3%, 4%, 5%, 10%, 15%, 20%, 25%, 30%, 35%, 40%, 45%, 50%, or higher, and any value therebetween, of the seed diameter. As another example, a drill bit may be used that generates an orifice that extends to a depth that is 0.1%, 0.25%, 0.5%, 1%, 1.5%, 2%, 2.5%, 3%, 4%, 5%, 10%, 15%, 20%, 25%, or deeper (such as, for example, any depth wherein after drilling the seed maintains viability), or any value therebetween, of the seed length. In some embodiments, a downcutting bit may be preferred as it has a cutting edge that slices down, resulting in a cleaner shoulder (or dado) and leaving a rougher bottom in the cut. In other embodiments, an upcutting bit, which pulls chips from the seed up and out of the cut, may be preferred.

As noted above, the methods provided herein may be applied to a variety of different seeds, including, but not limited to, crop seeds (e.g., seeds from corn (dent/field corn or sweet corn), soy, sunflower, rapeseed, cotton, etc.), cereal seeds (e.g., seeds from corn, barley, wheat, rice, oat, etc.), vegetable seeds (e.g., seeds from bean, brassica, cucumber, lettuce, melon, okra, pepper, spinach, squash, tomato, etc.), fruit seeds (e.g. seeds from melons including watermelon, pear, apple etc.), flower seeds, as well as tree seeds. In some embodiments, such as, for example, embodiments configured for use with some soy seeds, a ⅛ diameter, 140° carbide spotting drill bit may be used. In some embodiments, a shallow angle may be preferred to remove the seed coating but not much of the underlying cotyledon. In some embodiments, a 118-degree angle may be used. In some embodiments, such as embodiments configured for use with some corn seeds, an Amana 46200-K Solid Carbide Spektra™ Extreme Tool Life Coated Spiral Plunge bit may be used having ⅛ diameter×½×¼-inch shank. In some embodiments, such as embodiments configured for use with some sweet corn seeds, a downcutting bit or 140-degree bit may be used.

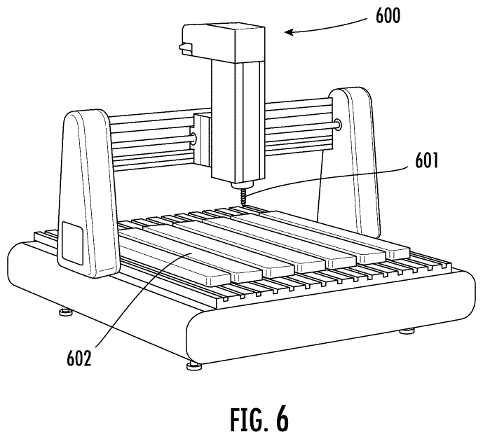

FIG. 6 depicts an example embodiment of a cutting device 600 that may be used to create an orifice in each seed affixed in the corresponding opening of a receptacle. In the depicted embodiment, the cutting device comprises a CNC router. The router 600 includes a drill head 601 and a surface 602, each which can be customized for a specific seed type. Any suitable rotary device like a router, a drill, or other rotary machine or the like can also be used. For example, a mini-CNC mill like the Iconic-4® produced by Axiom Tool Group, Inc may be used. The Iconic-4® has the capability of holding approximately 20 seed receptacles in the SBS microplate format (20 receptacles×96 seeds each=1920 seeds per deck). The Iconic-4 can be operated so as to be capable of cutting seeds up to 24,000 RPM for rapid processing, although any spindle speed may work. CNC routers can also be utilized in parallel or in series to increase throughput, or modified to include multiple gantries and spindles on a single table, or multiple spindles on a single gantry. In another alternative, a custom multi-channel drill head (for example, custom drill from vendor AutoDrill Lebanon, NJ 08833) can be manufactured and attached to a spindle to allow rapid parallel drilling (e.g., 2, 4, 6,8, 12, 24, 48, or 96 channels). In one example embodiment, a custom deck carrier fitted to the CNC mill has matched nest positions to fit the SBS formatted seed fixturing plates. Fixture locating features such as fixed and spring-loaded locating pins (also known as spring guide pins) may be used to allow the operator to secure and remove the seed receptacles to the deck of the CNC mill without the use of tools.

In some embodiments, faster spindle speeds may improve drilling throughput (e.g., the number seeds drilled per minute) and may provide less force imparted into the seed. If the spindle speed is too slow, or if the z feed rate is too fast, the seed may spin out of the receptacle (e.g., the foam) and/or the fixture of the seed may be lost. In such instances, the seed may become damaged. In some embodiments, higher speeds may reduce tear-out of the material. For example, if around 0.75 mm of material is removed from the seed (only enough to expose the inner genetics), high speeds may not cause the tool to slow down, which may minimize heat, and damage to the seed.

Returning to FIGS. 1, 2, at step 103, 203, the method of the depicted embodiment includes removing and discarding the debris created at the orifice of each seed or population of seeds by the cutting device. As such, the debris may include a seed fragment (e.g., seed chip, seed sample), seed dust, seed shaving, or any combination thereof based on the type of tool used for creating the orifice. For example, in certain embodiments where a drilling bit is used, the debris may include seed shavings and seed dust. In another embodiment, where a different cutting device is used for creating the orifice, the debris may include a seed fragment. In still another embodiment, where a corer is used for creating the orifice, the debris includes a seed core. Still other forms of seed debris may be formed based on the tool type, seed type, duration of sampling, location of sampling, and any combination thereof. In all cases, the debris may be defined as the seed material that is released during the creation of an orifice or well in the seed. Further, this debris includes seed material that is not used for sampling a biological trait or genotype of the seed. That is, the debris includes seed material that is thrown away before any steps related to extracting a biological sample from the seed can be performed. As a result of throwing away the debris before dispensing a sampling solution in the seed, contamination of in-seed sampling results with material from the debris may be averted, and sample drift related issues may be obviated.

Additional methods of capturing and/or removing seed dust include charged plates, ions, vacuums, pressure, dust filters, sticky traps, electrostatic precipitators, cyclone separators, baghouse filters, wet scrubbers, wet milling, wet flushing, etc.

In one example embodiment, the debris removal is performed by a cleaning tool. In particular embodiments, the cleaning may be performed after the orifice has been created. In other particular embodiments, the cleaning may be performed while the orifice is being created (that is, concurrent to the drilling). In the debris removal step, the portion of the seed endosperm or cotyledon that is removed by the cutting device during the creation of the orifice is removed and discarded by the cleaning tool. While prior art seed sampling approaches require a portion of the seed endosperm to be removed, subsequently the removed portion must be handled with utmost care to ensure that sufficient biological material can be extracted from it and further that the results can be reliably correlated with the seed from which the sample was taken. In this invention, as a result of the debris removal, the orifice or well created in the seed's endosperm or cotyledon region as well as the seed surface is cleaned and rendered free of any endosperm or cotyledon particles that are removed from the seed. This clean orifice or well is now the “sampling region” of the seed where a solution can be delivered.

In some embodiments, by using a drilling tool to remove a portion of the seed that is then discarded, various advantages may be achieved. First, a sample that is distinct from the seed is eliminated. This reduces handling issues resulting from the small size of the sample such as sample drift. In particular, since the debris is discarded, the possibility of sample drift from one well to another is averted. As another example, the reliance on complex sample management and tracking systems (e.g., LIMS), for ensuring that the identity of the portion removed from the seed is correctly correlated with the identity of the corresponding seed during all subsequent processing steps, is substantially reduced.

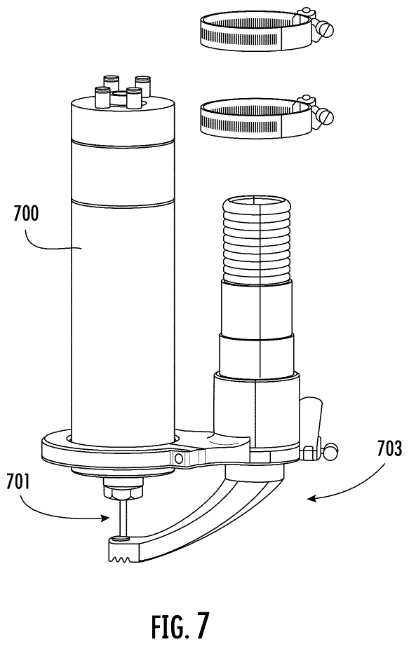

In some embodiments, a vacuum source is used to remove debris from each orifice, as well as any debris from the receptacle (e.g., into a dedicated container). In alternate embodiments, the debris may be removed using canned or forced air, or a positive air flow, that direct the debris away from the seeds and the receptacle (e.g., into a dedicated debris container). In some embodiments, the vacuum may be positioned adjacent to (e.g., coaxial or coplanar to) the drilling tool such that the debris is removed while the drilling tool is creating the orifice in the seed. One example of such an embodiment is shown at FIG. 7 wherein a CNC router 700 is customized to incorporate both a drill head 701 and an associated cleaning tool 703, depicted herein as a vacuum head. In one example, the vacuum head is the Iconic-4 dust-shoe that is modified to be fitted to a standard CNC router. Such a combined drilling and vacuum tool allows for simultaneous drilling and debris removal, ensuring that seed debris from the drilling of a given seed does not interfere with later analysis of seed material. In other words, a clean orifice can be provided wherein the seed sampling region of a given seed is free of any self-contamination from seed debris belonging to the same seed as well as cross-contamination from seed debris belonging to any other seed. In other embodiments the drilling tool aids in the cleaning of the orifice by creating a positive pressure locally during operation of the tool, thereby blowing the debris away from the seed. This also enhances the integrity of the subsequent molecular analysis. In still other embodiments, the combined drilling tool and cleaning tool may be included as part of an automated robotic arm or gantry system. In other embodiments, a dust shoe may be used, which is configured to trap and remove seed debris. In some embodiments, the dust shoe may include a plurality of bristles and/or the dust shoe may be connected to a vacuum source. In other embodiments, the dust shoe may not be connected to a vacuum source. Some embodiments may further include a secondary cleaning step to clean and remove seed dust from the dust shoe.

Alternative cleaning methods may include, but are not limited to, heat-based cleaning (e.g., induction, nichrome wire, or flame), use of a liquid stream, use of mechanical abrasion (e.g., a brush, sponge, or eraser), use of an ultrasonic liquid bath, soaking of at least the drilling tool and/or the drilled seed in water or a chemical bath (e.g., detergent/surfactant), use of ultraviolet generated ozone, or use of a sacrificial consumable (e.g., disposable foam or paper abrasive product to mechanically knock off debris while not substantially dulling the bit). Additional cleaning methods may include Chemical cleaning, Bubble cleaning, Ultrasonic cleaning, Heat/temperature cleaning, Detergent cleaning, Plasma cleaning, Cold plasma cleaning, Radiation cleaning, Irradiation cleaning, pH-based cleaning (acids/bases), Vacuum cleaning, Pressure cleaning, Electrochemical Advanced Oxidation Process (EAOP) cleaning, Laser cleaning, Water cleaning, Air cleaning, Consumable abrasion cleaning, UV (Ultraviolet) cleaning, =Solvent cleaning, DNAse, protease, chelation agents. An appropriate cleaning tool, as known in the art, may be used based on the selected cleaning method.

In still other embodiments, additionally or optionally, a drilling tool may be plated with a low friction or non-stick coating (e.g., Titanium Nitride or Nickel PTFE) to reduce sticking of the debris to the drilling tool and associated contamination or carryover. Select CNC mills may be equipped with automatic tool changers that allow the machine to drop-off and pick-up new cutting tools after they were soiled or have had too much wear. Further still, the CNC mill may be configured with multiple drilling tools in a configuration that matches the number and placement of openings in the receptacle so that each seed is drilled by a distinct drill. A common vacuum tool, or dedicated vacuum tools coupled to each drilling tool, may be operated to clean the debris. In some embodiments, a sleeve may be provided around the drilling tool (e.g., around the drill head of FIG. 7), wherein the sleeve is made of a material with an affinity to hold debris via a static charge, with or without the presence of an electric or magnetic field, or via Van der Waals forces. The sleeve may be used to capture the removed material. Additional drill coatings may include, but are noted limited to, Titanium Nitride (TiN), Titanium Carbonitride (TiCN), Aluminum Titanium Nitride (AlTiN), Titanium Aluminum Nitride (TiAlN), Diamond-like Carbon (DLC), Black Oxide, Cobalt, Zirconium Nitride (ZrN), and Teflon®.

Next, at steps 104, 204, the method includes applying a solution to the exposed portion of the cotyledon or endosperm, thereby forming an in-seed soak solution directly in the orifice in the seed. By pipetting the solution into the orifice multiple times, the soak solution comprises one or more extracted biological molecules such as, e.g., protein, DNA, RNA, carbohydrate, and/or glycan from the seed. Since the solution is applied directly to the exposed portion of the seed in the “well” created by the orifice, the need for a dedicated soaking tray or corresponding well space in the receptacle is averted. In addition, since the drilled seed itself is now the source of the biological material, instead of a removed portion of the seed, the need for complex LIMS systems for tracking the results of an analysis of the solution are reduced.

In one embodiment, the solution dispensed into the orifice is an alkaline solution used for extracting nucleic acids from the seed endosperm, such as DNA and RNA. The alkaline solution may comprise any known alkali suitable for DNA extraction, such as NaOH, KOH, etc. In other embodiments, the solution dispensed into the orifice may be a solution used for extracting nucleic acids proteins, carbohydrates, lipids or other biological material from the seed endosperm. In some embodiments, based on the compatibility of the solutions, one or more different extraction solutions may be sequentially dispensed to allow for sequential extraction of material (e.g., a first solution used for extracting DNA followed by a second solution used for extracting protein, etc.). Still other solutions that can be dispensed include an enzyme solution, water, or any other suitable solution that will extract an indicator of a trait or characteristic of interest.

An example embodiment of a solution used for extracting DNA from the exposed non-embryonic seed tissue is an alkali solution, such as the alkaline solution of U.S. Pat. No. 10,011,828 (the '828 patent). The alkali solution may, in some instances, be sodium hydroxide, or potassium hydroxide, or other alkali solutions. Unlike the approach of the '828 patent, which requires the entire seed to be soaked in the extraction solution, following a pre-treatment step, the present invention is able to perform the extraction by exposing only a portion of the seed to the solution in one step. In addition to reducing the volume of solution required to achieve DNA extraction (since the whole seed is not soaked), without compromising DNA yield or quality, the approach of the present invention reduces exposure of the seed embryo to the chemicals of the alkaline solution, improving germination efficiency and viability. Further, DNA extraction can be performed in a simple manner, without the need for pre-treatment of the seed. Furthermore, DNA can be extracted from seeds where the entire seed coat would otherwise be prone to damage or sloughing due to exposure to the alkaline solution.

Other DNA extraction solutions may be dispensed including but not limited to solutions comprising detergents (e.g., SDS, Tween20, EDTA, CTAB, PVP, chelating agents), enzymes, alcohol additives (e.g., PEG), etc. Further still, the extraction solution and protocol may be modified to include known methods of DNA extraction such as through the use of magnetic beads, alcohol precipitation, etc. In certain embodiments, the alkaline solution includes NaOH solutions comprising at least 5 mM, 10 mM, 15 mM, 20 mM, 30 mM, 40 mM, 50 mM, 100 mM, 150 mM, or 200 mM NaOH.

In some embodiments, optionally, a volume of water or alkali lysate soaking solution can be added to the orifice and allowed to incubate for a duration to increase the yield of biological material extracted (e.g., to increase the DNA or RNA yield). Herein, the volume can be a minimal volume that is sufficient to cover the bottom of the orifice, or it can be the entire volume of the orifice. In one example, 15 μl of water or alkali lysate is incubated in the orifice for 5 minutes or longer to increase DNA yield.

In some embodiments, such as where the receptacle is made of a deformable material, after an orifice has been drilled into the affixed seed and the debris removed, and prior to dispensing the solution into the orifice, the seed may be pushed deeper into the receptacle, automatically or manually, so as to create a channel or cavity extending from the surface of the opening to the orifice where additional seed soak solution can be dispensed and accumulated. This may be advantageous in applications where biological material yield can be limited.

The inventors have found that the method disclosed herein produces a surprising level of DNA yield. Moreover, some examples (such as those shown in the Example section) show an increase in DNA yield obtained through the disclosed method.

At step 105, 205, the method includes removing the seed soak solution and transferring the solution to a container having a fixed relationship with the seed or the position of the seed in the receptacle. For example, seed drilling, debris removal and in-seed soaking may be performed for each seed in a first 96-well plate format seed fixturing block and then the seed soak solution from each extraction may be transferred to the corresponding wells of a second 96-well plate where each opening has a fixed relationship with the openings of the first 96-well plate. In this way, the results of an analysis of the soak solution can be tracked and correlated with the corresponding source seed.

In a preferred embodiment, each seed receptacle and soak solution container has an identifier, such as a barcode or human readable label, saved in a database for tracking purposes. After transfer of the soak solution from the seed receptacle to the soak solution container, the drilled but viable seeds may be stored in the receptacle until the results (106A, 106B) of an analysis of the soak solution is completed.

In one example embodiment, an alkali solution comprising 20 mM NaOH is applied to the orifice in the seed. Further, the solution may be dispensed, and the soak solution extracted multiple times to provide a larger volume (e.g., for multiple types of assays) or for a greater DNA yield. For example, approximately 15 μl to 20 μl of solution may be initially pipetted into the orifice and 15 μl to 20 μl of solution may be transferred to an assay plate. Then, another 15 μl to 20 μl of solution may be pipetted into the orifice and 15 μl to 20 μl of solution may be again transferred to the assay plate (thereby providing 30 μl to 40 μl of soak solution from the same seed). This same process may be iterated multiple times. In an alternate embodiment, an additional well space can be created in the receptacle above the exposed seed by pushing the seed down so that a larger volume of seed soak solution can be generated.

In certain embodiments where the alkali solution used for extracting DNA from the seed is too basic to be compatible with downstream processes such as downstream PCR Taq polymerase reactions or sequencing reactions, a buffer or acid (e.g., TRIS or acetic acid) may be added to neutralize the solution to an acceptable pH. In certain embodiments, the seed soak solution can be removed from the seed by pipetting or other suitable means including but not limited to pumping or capillary actions. The transfer may be done by manual pipette, or by a multi-channel pipetting automation equipment (such as the Tecan Freedom Evo MultiChannel Arm™ MCA 96).

To improve pipetting performance, a hydrophobic coating/spray may be pre-applied to the seed before the drilling step. Addition of a hydrophobic coating can help contain the droplet (and larger droplets) of the solution or soak solution during the pipetting and mixing step and ensure that the droplet of soak solution does not fall outside of the seed orifice or get contaminated with maternal DNA from contact with the seed coat or be irrecoverably lost on the receptacle.

At step 106, 206, the method includes analyzing the extracted seed soak solution for the presence or absence of a characteristic or trait of interest. Analysis may be done using a Polymerase Chain Reaction (PCR) analysis. The DNA can be dispensed directly into a 96, 384, 1536, or 3897 well PCR plate with PCR chemistry, or tape with PCR chemistry and can be run directly on a plate based PCR system (such as the QuantStudio™ 6 Flex Real-Time PCR System). Other DNA or RNA analysis methods could also be used, such as isothermal amplification or next gen sequencing (NGS).

The disclosed methods, apparatus and systems are also configured to be compatible with existing and upcoming DNA sequencing-based technologies, such as Skim sequencing and Genotyping by Sequencing (GBS) due to the need for small DNA liquid volumes (about 4-10 μl, depending on pre-QC steps, for multiple assays). The methods and apparatus and systems are also compatible with legacy genotyping assays like Taqman or KASP, where higher volumes of DNA and/or DNA concentration can be required.

In other embodiments, the protein, carbohydrate, or oil profile of the seed may be analyzed by assaying the soak solution and inferring the presence or absence of characteristic traits in the seed. As non-limiting examples, DNA analysis may be performed to identify the presence of a transgene, vector, extrachromosomal component, an allele, a haplotype, a gene edit, an inversion, a deletion, an insertion, or a mutation in the genome of the seed.

In step 107, 207, the method includes identifying or selecting seeds of interest based on the analysis. The selected seeds are then moved forward for germination and propagation into viable plants that are introduced into breeding pipelines or research plots. The seeds of interest can be ejected from the receptacle. e.g., manually by an operator or by using automation. In some embodiments where the receptacle is made of a deformed material, following analysis, an ejecting device may be configured to push the seeds through the receptacle (such as a device comprising a flat ended tool in the collet) and configured to eject the seeds directly onto a sowing container (such as a clamshell or seed packet) or growth medium, or a growing container comprising growth medium. In some embodiments, the CNC device used for drilling the seeds may be modified so that the same equipment can be used for drilling and ejecting or selecting the seeds of interest. In other embodiments, the seeds may be selected or ejected using an industrial robot arm with a custom end effector. In still other embodiments, such as, for example, embodiments wherein a first CNC device is used for creating the orifice, a second CNC device may be provided in series with the first CNC device, to serve as the ejecting device.

In another embodiment, the seed receptacle may have a hole feature in the bottom of the receptacle which allows seeds to be ejected from the seed receptacle by an ejector pin. A hole in the bottom of the receptacle may not be needed if the receptacle is composed of foam material that allows the seed to be pushed through without disrupting neighboring seeds. If an industrial robot arm is used, the same robotic work cell may be used for both seed loading and seed ejection by use of a dual end effector on the robot to allow for both processes.

In some embodiments, to reduce consumables, once liquid handling on the receptacle is completed and seeds have been selected, the receptacle can be cleaned and sterilized for reuse. Once the soak solution analysis is complete, the seeds of interest may be sorted away from the others, while the unwanted seeds are culled.

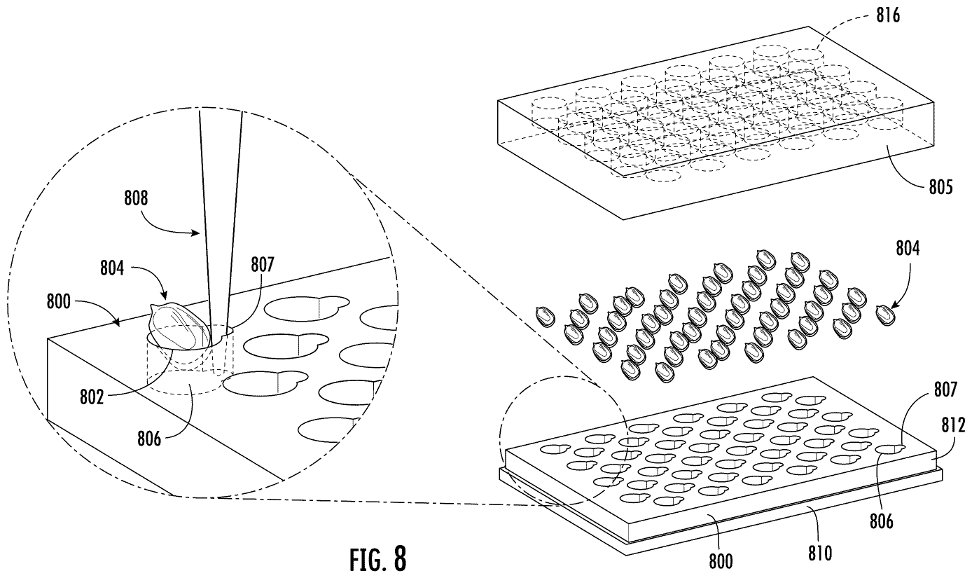

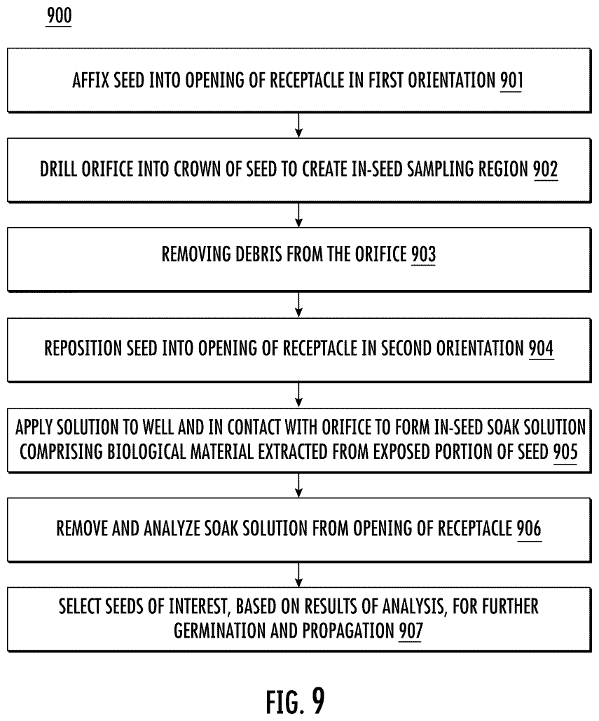

Another embodiment of an in-seed sampling method is disclosed at FIG. 9, implementing what may be referred to as the “bird bath method.”. In the method of FIG. 9, at step 901 seeds are first affixed into respective openings of a receptacle in a first orientation. At step 902, inner seed material is exposed by a cutting machine or alternatively by manually cutting the crowns of the seeds, which may preferably be water soaked for manual methods. At step 903, debris is removed from the orifice. Then, at step 904, following creation of an exposed orifice, the seeds are placed in a receptacle (such as, for example, receptacle 800 of FIG. 8) in a second, different orientation to enable sample solution application and seed soak solution extraction. In certain embodiments of the method, the seed can be initially inserted into a receptacle (such as, for example, receptacle 300 of FIG. 3) in a first orientation with the crown of the seed exposed, as previously described, and then, following drilling and debris removal, the seed may be removed from the receptacle (such as, for example, receptacle 300 of FIG. 3) and re-inserted into receptacle 800 of FIG. 8 in a second orientation, different from the first orientation, for solution application. The second orientation is shown in FIG. 8. In the depicted embodiment, the second orientation is opposite to the first orientation with the crown facing the bottom of the receptacle well and the tail or bottom portion of the seed extending out of, or co-planar to, the opening at the upper surface of the receptacle. A robotic arm comprising an associated vision system may be configured to initially place the seed in the receptacle in the first orientation and then subsequently remove and flip each seed to the second orientation, such as that shown in receptacle 800 of FIG. 8. At step 905, the first solution is applied to the well and in contact with the created orifice to form an in-seed soak solution comprising biological material extracted from the exposed portion of the seed. At step 906, the seed soak solution is removed from the well and analyzed, and at step 907, seeds of interest are selected based on the results of the analysis for further germination and propagation.

Although other configurations are possible, the receptacle 800 of FIG. 8 includes a rigid base substrate 810 onto which a receptacle layer 812 is located. In particular, the receptacle layer 812 of the depicted embodiment has a first surface attached to the rigid base substrate 810 with an SBS footprint (Society for Biomolecular Screening labware standard, accepted by various lab liquid handling equipment companies), and an opposite second surface having an array of openings for affixing the population of seeds. In various embodiments, the receptacle layer may be configured in a similar manner as the various receptacles described herein. Some embodiments need not include a rigid base substrate. FIG. 8 also shows a configuration of one embodiment of an example opening 802. As illustrated in the figure, the opening 802 includes a first section 806 configured to receive the seed 804 in either the first or second (as shown) orientation. The opening 802 further defines an inner reservoir 807 adjacent to the first section 806. In the depicted embodiment, the inner reservoir 807 extends laterally from the first section 806 and is configured to receive and hold a solution for contact with a portion of the seed 804 located in the first section 806 to form the seed soak solution. As shown, the inner reservoir 807 can be configured to receive a device 808 (such as, but not limited to, a pipette tip), which is configured to dispense a solution into and/or extract a solution from the inner reservoir 807. The depicted embodiment of FIG. 8 also includes an optional lid 805, which is configured to be placed over the receptacle 800. Although other configurations are possible, the lid 805 of the depicted embodiment includes a plurality of respective through-holes 816 that are configured to allow access to the seeds 804 located in the openings 802.

In other embodiments, seeds may be initially affixed in a first receptacle in a first orientation with the crown of the seed exposed (such as affixed in the receptacle of FIGS. 3-4 oriented as previously disclosed with reference to FIGS. 1-2). In some embodiments, a first orientation step to expose the seed may utilize a foam layer that may be positioned between the receptacle layer and a lid with holes, where the foam layer applies a compression holding force to affix and immobilize each seed before the step of exposing the seed material. Following creation of an orifice and cleaning of debris, the seeds may be transferred to a second receptacle (such as the receptacle of FIG. 8) and placed in a second orientation in openings of the second receptacle that have a defined relationship with the openings of the first receptacle. In the second orientation, the exposed orifice in the crown of the seed is directed into the receptacle opening while the tail end of the seed extends out of the top surface of the receptacle. Extraction solution is then applied to the orifice via opening 807 while the seed is in the second orientation. For example, instead of dispensing the solution directly into the orifice, as was done in FIGS. 1-2, the solution may be dispensed into the receptacle opening 807, thereby making indirect contact with the orifice while the seed is in the second orientation. Further still, as shown at FIG. 8, the receptacle opening may optionally have a reservoir section extending from the channel. The solution may be dispensed into the reservoir section from where it is in fluid communication with the orifice of the seed while the seed is placed in the receptacle opening in the second orientation.

In various embodiments, DNA yield may be a function of surface area. Full seed soaking for corn seeds may provide more DNA yield since it allows for more area to be exposed, up to the far edges of the crown. For the full seed soak method corn seeds may be pre-soaked in water to allow easy cutting (and greater DNA yield). When hand cut and pre-soaked more DNA may be obtained, but a tradeoff may be dealing with releasing DNA from the maternal seed coat that may not be representative of the endosperm and can make the analysis difficult or impossible. It is possible to soak only the top cut of the corn seed to minimize seed coat exposure—such as the bird bath method. The bird bath method may have challenges recovering liquid from the well since there is a large dead volume of liquid which may stick to the container and soak into the seed and which may not be easily captured over a large area with surface tension (an area big enough to hold the largest seed). In some instances, the bird bath method may be less preferable when it comes to a path of full automation since it requires picking and fixturing wet corn seeds of all shapes (especially round seeds without a flat face), and using a razor blade to cut off the crown, and then orienting the seed cut-down into a well with a small volume of extraction buffer, with added challenges of recovering the extraction buffer/seed soak solution.

With regard to soy seeds, it may not be possible to full seed soak soy without losing the seed coating which provides structural support to the seed. Without a seed coating the dicot seed can crack or split unless handled delicately. If extensive splits or cracks have occurred, the embryo and cotyledons may be severely disrupted or destroyed, and it may be unlikely that the seed will be able to germinate successfully. The damaged seed may lack the necessary internal structures and resources to support the growth of the seedling. When the soy seed coat falls off the seed when soaked, it rapidly expands, effectively causing the seed coat to become a loose bag around the seed, resulting in the seed not having structural support for sowing.

### Non-Limiting Embodiments

The present disclosure includes the following non-limiting embodiments:

Embodiments of methods for analyzing a seed or a population of seeds.

Embodiment 1: A method of analyzing a population of seeds, the method comprising: creating an orifice in each seed of the population of seeds, thereby exposing a portion of a cotyledon or endosperm of the seed; removing debris from the orifice; applying a first solution into contact with the orifice and onto the exposed portion of the cotyledon or endosperm, thereby forming a seed soak solution from the seed; and removing the seed soak solution while preserving germination viability of the seed.

Embodiment 2: The method of embodiment 1, further comprising affixing each seed of the population of seeds into a receptacle.

Embodiment 3: The method of embodiment 2, wherein the affixing step comprises orienting each seed in a common orientation.

Embodiment 4: The method of embodiment 3, wherein the common orientation comprises each seed being substantially coplanar or substantially tangential with a surface of the receptacle.

Embodiment 5: The method of embodiment 2, wherein the affixing step includes orienting each seed to align the crown of each seed to be substantially coplanar or substantially tangential with a surface of the receptacle.

Embodiment 6: The method of embodiment 2, wherein the affixing step comprises orienting each seed manually.

Embodiment 7: The method of embodiment 2, wherein the affixing step comprises orienting each seed automatically.

Embodiment 8: The method of embodiment 7, wherein the orienting step is done via a robotic arm.

Embodiment 9: The method of embodiment 8, wherein the seed is held by suction cup.

Embodiment 10: The method of embodiment 8, wherein the seed is first singulated by a lifting platform which is raised out of a bulk of seeds and sized to hold only one seed on the platform, wherein the singulated seed is rotated and a fixed position distance sensor captures a presence and/or an outside profile of the seed.

Embodiment 11: The method of embodiment 8, wherein the seed is first singulated by a lifting platform which is raised out of a bulk of seeds and sized to hold only one seed on the platform, wherein the singulated seed is held static and a rotating position distance sensor captures a presence and/or an outside profile of the seed.

Embodiment 12: The method of embodiment 1, wherein the seed soak solution comprises at least one of a protein, carbohydrate, DNA, or RNA from the seed.

Embodiment 13: The method of embodiment 1, further comprising: extracting DNA from the seed soak solution; analyzing the extracted DNA to determine a genetic characteristic of the seed; and selecting at least one seed of interest from the population of seeds based on the analysis.

Embodiment 14: The method of embodiment 2, wherein the receptacle comprises an array of openings, each opening configured to hold an individual seed of the population of seeds in a common orientation.

Embodiment 15: The method of embodiment 2, wherein the receptacle comprises a compressible material having a plurality of dimples on an outer surface thereof, such that affixing the seed into the receptacle comprises applying a force to drive the seed into the material so that the seed is held in an orientation in a dimple of the receptacle.

Embodiment 16: The method of embodiment 15, wherein affixing the seed is done using a tool to apply the force.

Embodiment 17: The method of embodiment 1, further comprising removing a portion of a seed coat at the crown of the seed prior to creating the orifice.

Embodiment 18: The method of embodiment 1, further comprising: germinating the seed after removing the seed soak solution; and growing a viable plant from the germinated seed.

Embodiment 19: The method of embodiment 1, wherein creating an orifice comprises drilling into the seed.

Embodiment 20: The method of embodiment 19, further comprising removing debris created by the drilling step with a vacuum.

Embodiment 21: The method of embodiment 1, wherein creating an orifice comprises puncturing the seed.

Embodiment 22: The method of embodiment 21, further comprising removing debris created by the puncturing step from the puncture through a needle.

Embodiment 23: The method of embodiment 1, wherein the first solution comprises an alkali solution.

Embodiment 24: The method of embodiment 1, wherein the first solution comprises an enzyme solution.

Embodiment 25: The method of embodiment 1, wherein the first solution comprises water.

Embodiment 26: The method of embodiment 2, wherein the receptacle is configured to hold the first solution.

Embodiment 27: The method of embodiment 26, wherein the first solution in the receptacle comprises a lysis buffer.

Embodiment 28: The method of embodiment 27, wherein the seed soak solution comprises an aggregate.

Embodiment 29: The method of embodiment 28, further comprising agitating the seed soak solution before removal.

Embodiment 30: The method of embodiment 29, wherein removing the seed soak solution from the receptacle comprises extracting a material using a suspension.

Embodiment 31: The method of embodiment 30, wherein the suspension comprises at least one of a group comprising an alkali, an enzyme, a chelate, and a detergent.

Embodiment 32: The method of embodiment 31, further comprising: adding an abrasive material to the seed soak solution in the receptacle; and agitating the solution seed soak solution in the receptacle to collect a protein, DNA, RNA, carbohydrate, and/or glycan from the seed.

Embodiment 33: A method for analyzing a population of seeds, the method comprising: affixing each seed of the population of seeds into a first receptacle in a first orientation; creating an orifice in a crown of each seed of the population of seeds, thereby exposing a portion of a cotyledon or endosperm of each seed; applying a first solution into the orifice and onto the exposed portion of the cotyledon or endosperm, thereby forming a seed soak solution from the seed while preserving germination viability of the seed; and transferring at least one seed of the population of seeds having an orifice into a second receptacle in a second orientation.

Embodiment 34: The method of embodiment 33, further comprising removing debris from the orifice.

Embodiment 35: The method of embodiment 33, wherein the second receptacle comprises respective openings, each opening of the second receptacle comprising a first section for receiving the seed in the second orientation and an inner reservoir adjacent to the first section configured to receive and hold the first solution such that the first solution contacts the exposed portion of the cotyledon or endosperm.

Embodiment 36: The method of embodiment 33, wherein transferring the at least one seed having an orifice comprises reorienting the at least seed from the first orientation in the first receptacle to a second orientation in the second receptacle.

Embodiment 37: The method of embodiment 33, wherein in the first orientation, a crown of the seed is substantially coplanar with an upper surface of the first receptacle, and in the second orientation, the crown of the seed is substantially coplanar or substantially tangential with a bottom surface of an opening in the second receptacle.

Embodiment 38: The method of embodiment 33, wherein the seed soak solution comprises a protein, DNA, RNA, carbohydrate, and/or glycan.

Embodiment 39: The method of embodiment 35, wherein applying the first solution into the orifice comprises applying the solution to the inner reservoir.

Embodiment 40: The method of embodiment 35, wherein the inner reservoir of the opening extends laterally from the first section.

Embodiment 41: The method of embodiment 33, further comprising pre-soaking each seed of population of seeds.

Embodiment 42: The method of embodiment 41, wherein pre-soaking each seed of the population of seeds comprises soaking a material and holding the seed within the material before affixing the seed into the receptacle.

Embodiment 43: The method of embodiment 41, wherein pre-soaking each seed of the population of seeds comprises soaking the receptacle after affixing the seed into the receptacle.

Embodiments of Systems and Apparatus for use in affixing a seed or a population of seeds for subsequent analysis.

Embodiment 44: An apparatus for affixing a population of seeds for subsequent analysis, the apparatus comprising: a rigid base substrate; and a receptacle layer for affixing the population of seeds, the receptacle layer having a first surface attached to the rigid base substrate, and an opposite second surface having an array of openings for affixing the population of seeds.

Embodiment 45: The apparatus of embodiment 44, wherein the first surface is a gel, elastomer, or foam.

Embodiment 46: The apparatus of embodiment 44, wherein the second surface comprises a substantially flat plane configured to accept robot placement of seeds on a known XY pitch and depth.

Embodiment 47: The apparatus of embodiment 44, wherein each opening comprises a first section configured to hold a seed and an inner reservoir adjacent to the first section configured to hold a solution so that the solution contacts a portion of the seed.

Embodiment 48: The apparatus of embodiment 44, wherein the receptacle layer is reusable.

Embodiment 49: The apparatus of claim 44, further comprising a lid.

Embodiment 50: The apparatus of embodiment 49, further comprising a foam layer between the receptacle layer and the lid, where the foam layer applies a holding force to each affixed seed.

Embodiment 51: The apparatus of embodiment 49, wherein the lid comprises a number of through-holes configured to allow access to the seed or population of seeds held in the plurality of openings.

Embodiment 52: The apparatus of embodiment 44, wherein the population of seeds is held within the receptacle such that the population of seeds have a set of known XY coordinates and Z coordinates (relative to the crown) and share a common orientation.

Embodiment 53: The apparatus of embodiment 44, further comprising a number of additional receptacle layers.

Embodiment 54: The apparatus of embodiment 44, wherein the receptacle layer comprises a foam with a memory such that the foam returns to an original shape after the collection of seeds is affixed into the plurality of openings.

Embodiment 55: The apparatus of embodiment 44, wherein the receptacle layer comprises a foam having a full plastic deformation.

Embodiment 56: A receptacle for holding a population of seeds for subsequent analysis, the receptacle comprising: a surface having a respective opening for affixing each seed of the population of seeds, the opening comprising a first section configured to hold an individual seed and an inner reservoir adjacent to the first section configured to hold a first solution so that the first solution contacts a portion of the individual seed to form a seed soak solution.

Embodiment 57: The receptacle of embodiment 56, wherein the receptacle is reusable.

Embodiment 58: The receptacle of embodiment 56, wherein the receptacle comprises a foam.

Embodiment 59: The receptacle of embodiment 58, wherein the foam has a memory such that the foam returns to an original shape after the population of seeds is affixed into the at least one opening.

Embodiment 60: The receptacle of embodiment 56, wherein the population of seeds comprises a plurality of seeds, wherein each seed of the population of seeds is affixed within a respective opening of a plurality of openings such that each seed of the population of seeds has a set of known coordinates and the plurality of seeds share a common orientation.

Embodiment 61: The receptacle of embodiment 56, wherein the inner reservoir is configured to allow a device to enter and extract the seed soak solution without contacting the seed.

Embodiment 62: An opening in a receptacle for holding a seed for subsequent analysis, the opening comprising: a first section defined by the receptacle configured for an insertion of the seed; and an inner reservoir adjacent to the first section configured to hold a first solution so that the first solution contacts a portion of the seed to form a seed soak solution.

Embodiment 63: The opening of embodiment 62, wherein the inner reservoir is configured to allow a device to enter and extract the seed soak solution without contacting the seed.

Embodiment 64: The opening of embodiment 62, wherein the inner reservoir extends laterally from the first section.

Embodiment 65: The opening of embodiment 62, wherein the receptacle comprises a foam having a memory such that the foam returns to an original shape after the seed is inserted into the space.

Embodiment 66: The opening of embodiment 62, wherein the receptacle comprises a foam having a full plastic deformation where the insertion of the seed forms the inner reservoir.

Embodiment 67: The opening of embodiment 62, wherein the first section is configured to hold the seed in a first orientation such that a crown of the seed is substantially coplanar or substantially tangential with an upper surface of the receptacle.

Embodiment 68: The opening of embodiment 62, wherein the first section is configured to hold the seed in a second orientation such that a crown of the seed is substantially coplanar or substantially tangential with a bottom surface of the receptacle.

Embodiments of methods of creating an orifice in a seed for subsequent analysis.

Embodiment 69: A method of creating an orifice in a seed for subsequent analysis, the method comprising: orienting the seed in a first orientation, such that a crown of the seed is exposed; creating an orifice in the crown of the seed thereby exposing a portion of a cotyledon or endosperm of the seed; and removing debris from the orifice.

Embodiment 70: The method of embodiment 69, wherein creating an orifice in the crown of the seed comprises drilling, using a downcut bit, into the crown of the seed.

Embodiment 71: The method of embodiment 69, wherein creating an orifice in the crown of the seed comprises drilling, using an upcut bit, into the crown of the seed.

Embodiment 72: The method of embodiment 69, wherein removing debris from the orifice comprises vacuuming debris from the orifice.

Embodiment 73: The method of embodiment 69, wherein removing debris from the orifice comprises using compressed air to clear debris from the orifice.

Embodiment 74: The method of embodiment 69 wherein removing the debris from the orifice comprises using positive air flow to clear debris from the orifice.

Embodiment 75: The method of embodiment 69, wherein the orienting step comprises holding the seed in a receptacle such that the crown of the seed is coplanar or tangential with an upper surface of the receptacle.

Embodiment 76: The method of embodiment 69, wherein creating an orifice comprises puncturing the crown of the seed such that a portion of the cotyledon or endosperm is exposed.

Embodiment 77: The method of embodiment 1, further comprising:
extracting RNA from the seed soak solution; analyzing the extracted RNA to determine a gene expression characteristic of the seed; and selecting at least one seed of interest from the population of seeds based on the analysis.

Embodiment 78: The method of embodiment 1, further comprising: extracting protein from the seed soak solution; analyzing the extracted protein to determine a characteristic of the seed; and selecting at least one seed of interest from the population of seeds based on the analysis.

Embodiment 79: The method of embodiment 1 wherein the seed has a seed coat, and the first solution is in contact with less than 25% of the seed coat surface area.

Embodiment 80: A method of analyzing a population of seeds, the method comprising: creating an orifice in each seed of the population of seeds, thereby exposing a portion of a cotyledon or endosperm of the seed; applying a first solution into contact with the orifice and onto the exposed portion of the cotyledon or endosperm, thereby forming a seed soak solution from the seed; and removing the seed soak solution while preserving germination viability of the seed.

Embodiment 81: The method of embodiment 80 wherein debris is substantially removed during creation of the orifice.

Embodiment 82: An apparatus for affixing a population of seeds for subsequent analysis, the apparatus comprising: a deformable substrate having a surface with an array of indentations or openings for affixing the population of seeds.

Embodiment 83: The apparatus of embodiment 82, wherein the deformable substrate is a gel, elastomer, or foam.

Embodiment 84: The apparatus of embodiment 82, wherein the deformable substrate is foam having a density from about 0.75 lbs/ft³ to about 2.5 lbs/ft³ and a compression force deflection of about 2 psi to about 25 psi.

Embodiment 85: The apparatus of embodiment 82, wherein the surface comprises a substantially flat plane configured to accept robot placement of seeds on a known XY pitch and depth.

### EXAMPLES

The following Examples are illustrative only and do not limit the scope of the present disclosure or the appended claims.

### Example 1: Seed Analysis Protocol

Materials: Custom phenol or polyisocyanurate foam block with 96 target positions or holes for 9 mm pitch according to SBS plate standard, approximately 1″ deep. 20 mM of NaOH solution. 0.5M TRIS solution. 100 μl PCR plate (e. g,, #4ti-0960 FrameStar® 96 Well Skirted PCR Plate).

Equipment and tools: 96 channel liquid handler, mini mill with vacuum collection and block fixturing, mill tooling/drill bits (Soy: ⅛ Ø 140° Carbide Spotting Drill; Corn: Amana 46200-K Solid Carbide Spektra™ Extreme Tool Life Coated Spiral Plunge ⅛ Dia×½×¼ Inch Shank), plate centrifuge (e.g., Thermo Scientific™ Sorvall™ Legend™ XF Centrifuge), custom press tool (to push all seeds down to same vertical/Z depth).

Procedure: Load seeds on 9 mm pitch into 96 positions (by hand, with vacuum manifold with suction cups, or by other automated means). Push all seeds down to same vertical position so the top of the seed, regardless of seed length, are all on the same plane. Mill large surface of seed to create an orifice while vacuuming out all debris (approximately 0.75 mm deep). Any visible leftover debris may inhibit PCR due to inhibitors (proteins, phenols, etc.), cause well-to-well differences, and associated data quality issues. Using a liquid handler, such as a Tecan Evo 150 MCA equipped with a 96-channel head, dispense 70 μl of 20 mM NaOH and mix the solution 20 times to form a homogenous seed soak solution. Transfer the seed soak solution to a new 96 well PCR plate. Spin the plate in centrifuge to 4000 RPM and transfer 32 ul or greater to a new 96 well PCR plate. If greater yield is desired, incubate at 65° C. overnight or 3 hours at 95° C. Neutralize the pH by adding 1 μl of 0.5M TRIS Hydrochloride per 10 μl of soak solution. The DNA soak solution is now ready for PCR and/or tGBS library prep. Typically less than 20 μl of material is needed to run many thousands of markers on tGBS. Genotyping platforms such as Nexar require approximately 1 μl per assay and would require more DNA yield. Both corn and Soy samples were run using the above method utilizing Agriplex tGBS analysis with success.

### Example 2: PCR Test Determining DNA Yield on Corn Seed

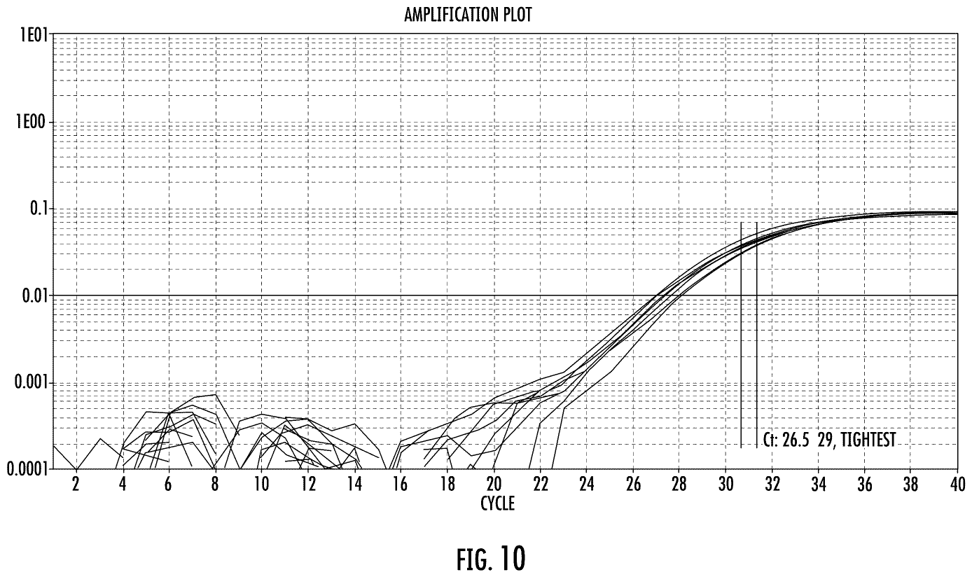

FIG. 10 is a real-time amplification plot of an example test to determine DNA yield. A real-time PCR test run was performed on a corn seed with 175 mM NaOH, dispensing 17 μl on the seed orifice, 4× times with 20 mixes, then centrifuged, and transferred to a new plate with 68 μL of 100 mM TRIS Hydrochloride. A downcutting bit with a ⅛″ bit was used to expose the endosperm of the corn seed. The realtime PCR test determines the relative DNA yield and quality. Multiple variables were tested to determine the optimal molarity of the alkaline solution and neutralizing buffer. The plot is a realtime or qPCR plot showing fluorescent signal on the Y axis and PCR cycle on the X axis. During the PCR reaction a heated and cooled TAQ enzyme replicates the DNA region of interest and enables a fluorescent signal.

Signals read after each cycle and the signal is recorded, allowing a user to indirectly quantify how much DNA exists in the sample. This approach was used to determine how much DNA was harvested.

A second variable that was successfully used was 20 mM NaOH, comprising 15 μl soak, 20 mixes, and 15 μl water. Because the molarity of the NaOH lysate buffer is so low, no TRIS Hydrochloride buffer is required to neutralize the pH for the PCR reaction (and associated Taq polymerase enzyme).

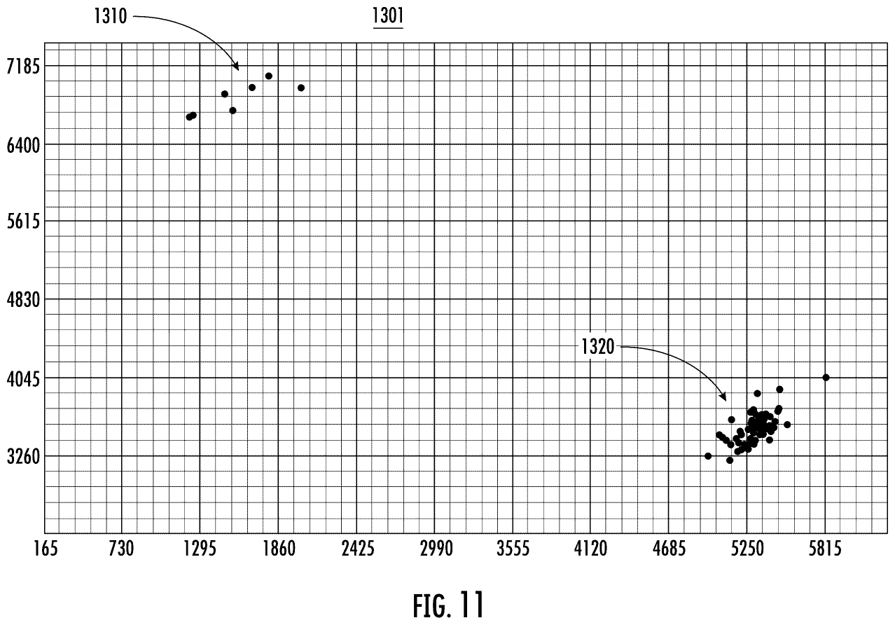

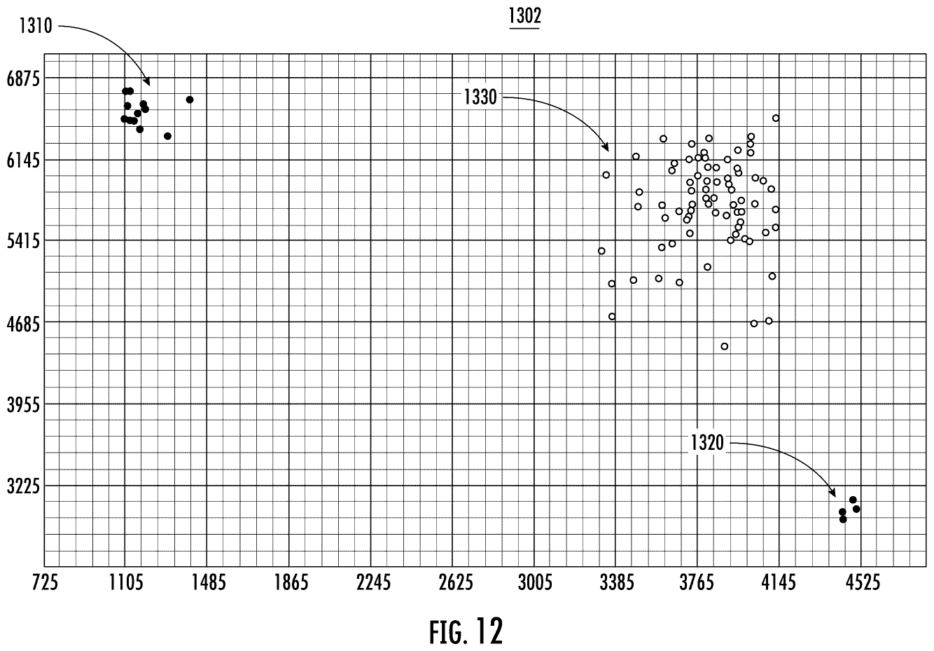

FIG. 11 is a PCR plot of an example test utilizing the soak solution to determine the presence of alleles an endpoint PCR test. An endpoint PCR reaction test was run on the same corn seed as shown in FIG. 10, with 175 mM NaOH of DNA with 20 mixes and 100 mM TRIS, using a downcutting ⅛″ bit. The PCR endpoint reaction has a multiplex assay which either amplifies an allele from the father, mother or one of both (heterogenous [HET] is shown in the middle cluster). A large number of samples were placed in a water bath and thermocycled in bulk, before being put on a reader to read the fluorescent signal for allele 1 (i.e., grouping 1310 in plot 1301) or allele 2 (i.e., grouping 1320 in plot 1301). FIG. 12 is a PCR plot of an example test determining DNA clustering performance for homogeneous (1310, 1320) and heterogeneous (1330) allele clusters using a different SNP assay. An endpoint PCR reaction test was run on the same corn seed as shown in FIG. 10, with 17 μL 174 mM NaOH of DNA with 20 mixes and 17 μL 100 mM TRIS Hydrochloride, upon a seed exposed using a downcutting ⅛″ bit. The PCR endpoint reaction has a multiplex assay which either amplifies the presence an allele on either the X or Y axis, or combination of both. A number of samples were placed in a water bath and thermocycled in bulk, before being put on a reader device to read the fluorescent signal for allele 1 (grouping 1310 in plot 1302), allele 2 (grouping 1320 in plot 1302), or a mix of alleles forming a heterogenous cluster (grouping 1330 in plot 1302).

### Example 3: PCR Test Determining DNA Yield on Soy Seed

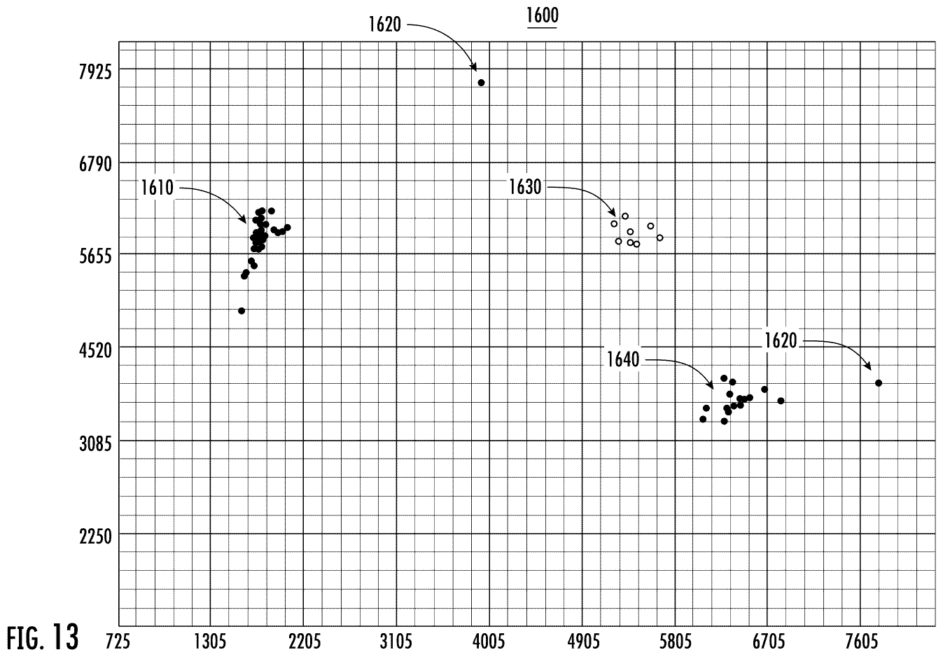

FIG. 13 is a PCR plot of an example test determining DNA cluster quality as shown in graph 1600. An endpoint PCR reaction test was run on a soy seed population, with 20 μl DNA with 100 mM NaOH seed soak solution with 20 mixes and 40 μl TRIS Hydrochloride to neutralize the pH, using a upcutting 140-degree point angle and ⅛″ bit. The PCR endpoint reaction shows a multiplex assay amplifying the presence of one or both alleles. A number of samples were placed in a water bath and thermocycled in bulk on an F4 population showing segregating materials with a heterogeneous cluster (center). The samples were put on a reader to read the fluorescent signal for allele 1 (grouping 1610 in plot 1600), allele 2 (grouping 1640 in graph 1600), a heterogenous cluster of both alleles (grouping 1630 of plot 1600) and indeterminate outliers (grouping 1620 in plot 1600).

Many modifications and other implementations of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

1. A method of analyzing a population of seeds, the method comprising:
creating an orifice in each seed of the population of seeds, thereby exposing a portion of a cotyledon or endosperm of the seed;
removing debris from the orifice;
applying a first solution into contact with the orifice and onto the exposed portion of the cotyledon or endosperm, thereby forming a seed soak solution from the seed; and
removing the seed soak solution while preserving germination viability of the seed.

2. The method of claim 1, further comprising affixing each seed of the population of seeds into a receptacle.

3. The method of claim 2, wherein the affixing step comprises orienting each seed in a common orientation.

4. The method of claim 3, wherein the common orientation comprises each seed being substantially coplanar or substantially tangential with a surface of the receptacle.

5. The method of claim 2, wherein the affixing step includes orienting each seed to align the crown of each seed to be substantially coplanar or substantially tangential with a surface of the receptacle.

6. The method of claim 2, wherein the affixing step comprises orienting each seed manually.

7. The method of claim 2, wherein the affixing step comprises orienting each seed automatically.

8. The method of claim 7, wherein the orienting step is done via a robotic arm, optionally wherein the seed is held by a suction cup.

9. (canceled)

10. The method of claim 8, wherein the seed is first singulated by a lifting platform which is raised out of a bulk of seeds and sized to hold only one seed on the platform, wherein the singulated seed is rotated and a fixed position distance sensor captures a presence and/or an outside profile of the seed.

11. The method of claim 8, wherein the seed is first singulated by a lifting platform which is raised out of a bulk of seeds and sized to hold only one seed on the platform, wherein the singulated seed is held static and a rotating position distance sensor captures a presence and/or an outside profile of the seed.

12. The method of claim 1, wherein the seed soak solution comprises at least one of a protein, carbohydrate, DNA, or RNA from the seed.

13. The method of claim 1, further comprising:
extracting DNA from the seed soak solution;
analyzing the extracted DNA to determine a genetic characteristic of the seed; and
selecting at least one seed of interest from the population of seeds based on the analysis.

14. The method of claim 2, wherein the receptacle comprises an array of openings, each opening configured to hold an individual seed of the population of seeds in a common orientation.

15. The method of claim 2, wherein the receptacle comprises a compressible material having a plurality of dimples on an outer surface thereof, such that affixing the seed into the receptacle comprises applying a force to drive the seed into the material so that the seed is held in an orientation in a dimple of the receptacle.

16. The method of claim 15, wherein affixing the seed is done using a tool to apply the force.

17. The method of claim 1, further comprising removing a portion of a seed coat at the crown of the seed prior to creating the orifice.

18. The method of claim 1, further comprising:
germinating the seed after removing the seed soak solution; and
growing a viable plant from the germinated seed.

19. The method of claim 1, wherein creating an orifice comprises drilling or puncturing into the seed.

20. The method of claim 19, further comprising removing debris created by the drilling or puncturing step with a vacuum.

21-22. (canceled)

23. The method of claim 1, wherein the first solution comprises an alkali solution, an enzyme solution, or water.

24-25. (canceled)

26. The method of claim 2, wherein the receptacle is configured to hold the first solution, and wherein the first solution comprises a lysis buffer.

27-28. (canceled)

29. The method of claim 1, further comprising agitating the seed soak solution before removal.

30-31. (canceled)

32. The method of claim 26, further comprising:
adding an abrasive material to the seed soak solution in the receptacle; and
agitating the solution seed soak solution in the receptacle to collect a protein, DNA, RNA, carbohydrate, and/or glycan from the seed.

33. A method for analyzing a population of seeds, the method comprising:
affixing each seed of the population of seeds into a first receptacle in a first orientation;
creating an orifice in a crown of each seed of the population of seeds, thereby exposing a portion of a cotyledon or endosperm of each seed;
removing debris from the orifice;
applying a first solution into the orifice and onto the exposed portion of the cotyledon or endosperm, thereby forming a seed soak solution comprising a protein, DNA, RNA, carbohydrate, and/or glycan from the seed while preserving germination viability of the seed; and
transferring at least one seed of the population of seeds having an orifice into a second receptacle in a second orientation.

34. (canceled)

35. The method of claim 33, wherein the second receptacle comprises respective openings, each opening of the second receptacle comprising a first section for receiving the seed in the second orientation and an inner reservoir adjacent to the first section configured to receive and hold the first solution such that the first solution contacts the exposed portion of the cotyledon or endosperm; and wherein transferring the at least one seed having an orifice comprises reorienting the at least seed from the first orientation in the first receptacle to a second orientation in the second receptacle.

36. (canceled)

37. The method of claim 33, wherein in the first orientation, a crown of the seed is substantially coplanar with an upper surface of the first receptacle, and in the second orientation, the crown of the seed is substantially coplanar or substantially tangential with a bottom surface of an opening in the second receptacle.

38. (canceled)

39. The method of claim 35, wherein applying the first solution into the orifice comprises applying the solution to the inner reservoir, wherein the inner reservoir of the opening extends laterally from the first section.

40. (canceled)

41. The method of claim 33, further comprising pre-soaking each seed of population of seeds.

42. The method of claim 41, wherein pre-soaking each seed of the population of seeds comprises soaking a material and holding the seed within the material before affixing the seed into the receptacle.

43. The method of claim 41, wherein pre-soaking each seed of the population of seeds comprises soaking the receptacle after affixing the seed into the receptacle.

44-68. (canceled)

69. A method of creating an orifice in a seed for subsequent analysis, the method comprising:
orienting the seed in a first orientation, such that a crown of the seed is exposed;
creating an orifice in the crown of the seed thereby exposing a portion of a cotyledon or endosperm of the seed; and
removing debris from the orifice.

70. The method of claim 69, wherein creating an orifice in the crown of the seed comprises drilling, using a downcut bit, into the crown of the seed.

71. The method of claim 69, wherein creating an orifice in the crown of the seed comprises drilling, using an upcut bit, into the crown of the seed

72. The method of claim 69, wherein removing debris from the orifice comprises vacuuming debris from the orifice, using compressed air to clear debris from the orifice, or using positive air flow to clear debris from the orifice.

73-74. (canceled)

75. The method of claim 69, wherein the orienting step comprises holding the seed in a receptacle such that the crown of the seed is coplanar or tangential with an upper surface of the receptacle.

76. (canceled)

77. The method of claim 1, further comprising:
extracting RNA from the seed soak solution;
analyzing the extracted RNA to determine a gene expression characteristic of the seed; and
selecting at least one seed of interest from the population of seeds based on the analysis.

78. The method of claim 1, further comprising:
extracting protein from the seed soak solution;
analyzing the extracted protein to determine a characteristic of the seed; and
selecting at least one seed of interest from the population of seeds based on the analysis.

79. The method of claim 1 wherein the seed has a seed coat, and the first solution is in contact with less than 25% of the seed coat surface area.

80. A method of analyzing a population of seeds, the method comprising:
creating an orifice in each seed of the population of seeds, thereby exposing a portion of a cotyledon or endosperm of the seed, wherein debris is substantially removed during creation of the orifice;
applying a first solution into contact with the orifice and onto the exposed portion of the cotyledon or endosperm, thereby forming a seed soak solution from the seed; and
removing the seed soak solution while preserving germination viability of the seed.

81-85. (canceled)
